(19) United States
(12) Patent Application Publication
(10) Pub. No.: US 2010/0054598 A1
(43) Pub. Date: Mar. 4, 2010

(54) IMAGE PROCESSING APPARATUS, IMAGE FORMING APPARATUS, IMAGE PROCESSING APPARATUS CONTROL METHOD, AND STORAGE MEDIUM

(76) Inventor: Makio GOTOH, Osaka (JP)

Correspondence Address: BIRCH STEWART KOLASCH & BIRCH, PO BOX 747, FALLS CHURCH, VA, 22040-0747, US

(21) Appl. No.: 12/547,989

(22) Filed: Aug. 26, 2009

(30) Foreign Application Priority Data
Aug. 27, 2008 (JP) 2008-218838

(51) Int. Cl. G06K 9/34

(52) U.S. Cl. 382/173

(57) ABSTRACT

An image processing apparatus includes a segmentation process section for performing a segmentation process on image data and a spatial filer section for performing a spatial filter process on the image data. The spatial filter section performs, on image data for use in printing or facsimile transmission, a spatial filer process that varies according to a result of the segmentation process, and performs, on image data for use in a preview display, a spatial filter process irrelevant to the result of the segmentation process. This makes it possible to provide an image processing apparatus capable of suppressing deterioration in quality of an image whose preview is displayed.

This Nonprovisional application claims priority under 35 U.S.C. § 119(a) on Patent Application No. 2008-218838 filed in Japan on Aug. 27, 2008, the entire contents of which are hereby incorporated by reference.

### TECHNICAL FIELD

The present invention relates to an image processing apparatus for processing image data on a preview (thumbnail) to be displayed by a display device, an image forming apparatus, an image processing apparatus control method, a control program, and a storage medium.

### BACKGROUND ART

Image forming apparatuses such as copying machines and multifunction printers display, in accordance with the type of document and the setting conditions (e.g., print density, enlarging/reducing ratio, single-side printing/duplex printing, margin size), image processing on image data indicative of an image to be printed. Furthermore, some image forming apparatuses causes a display device, in accordance with the image data subjected to image processing, a preview of the image to be printed. It should be noted that the preview display takes the form of a page-by-page display of each image to be printed or a simultaneous display of pages of images to be printed.

Moreover, normally, such an image forming apparatus performs a segmentation process in accordance with image data, and then executes, on the image data, image processing reflecting the result of the segmentation process, thus performing, on image data whose preview is to be displayed, the image processing reflecting the result of the segmentation process. For example, Patent Literature 1 below discloses a technique for judging, for each pixel of image data, whether or not the pixel belongs to a text area, for performing error diffusion on a text area without a summation of values of errors to avoid deformation in the contour of a text portion, and for performing a subtractive process on a nontext area by normal error diffusion.

### Citation List

### Patent Literature 1

Japanese Patent Application Publication, Tokukai, No. 2003-224734 A (Publication Date: Aug. 8, 2003)

### Patent Literature 2

Japanese Patent Application Publication, Tokukaihei, No. 9-135316 A (Publication Date: May 20, 1997)

### SUMMARY OF INVENTION

Technical Problem

However, in the case of a preview display of an image by an image forming apparatus, it is usual that an image read by a scanner of 600 dpi or 1,200 dpi is displayed by a display device of 72 dpi or 96 dpi and that a display device for displaying a preview is small in size. Therefore, it is necessary to perform a process of downsampling pixels (by interpolation) in accordance with the size and resolution of a display screen.

However, image data composed of segmentation class signals cannot be downsampled with interpolation, but are simply downsampled (i.e., downsampled without interpolation). This causes a lack of image information in some pixels, thus causing deterioration in image quality as a result. For example, as the result of a simple downsampling process performed on image data composed of segmentation class signals, a pixel supposed to be treated as a text is not treated as such; therefore, an image containing a nontext pixel is generated in a text area. This causes degradation in legibility of texts, thus causing deterioration in image quality.

The present invention has been made to solve the foregoing problems, and it is an object of the present invention to provide an image processing apparatus capable of inhibiting deterioration in image quality of an image whose preview is displayed.

Solution to Problem

In order to attain the foregoing object, an image processing apparatus includes: a segmentation process section which performs a segmentation process on image data; and an image processing section which performs image processing on the image data, when the image data are data for use in printing or transmission, the image processing section performing first image processing that varies according to a result of the segmentation process, when the image data are data for use in a preview display, the image processing section performing a downsampling process on the image data and neglecting to perform the first image processing.

Advantageous Effects of Invention

The arrangement of the present invention does not subject image data for use in a preview display to image processing reflecting the result of a segmentation process, thus bringing about an effect of suppressing deterioration in quality of an image whose preview is displayed.

For a fuller understanding of the nature and advantages of the invention, reference should be made to the ensuing detailed description taken in conjunction with the accompanying drawings.

### BRIEF DESCRIPTION OF DRAWINGS

FIG. 1 is a block diagram showing an image forming apparatus of the present embodiment and showing the flow of image data in a printing process in a copier mode and a full-color mode.

FIG. 2 shows block diagrams showing a part inside of an image processing apparatus (a) performing a printing process in the copier mode and a single-color mode and (b) performing a printing process in the copier mode and a two-color mode.

FIG. 3 is a block diagram showing the image forming apparatus of the present embodiment and showing the flow of image data in a preview display process in the copier mode and the full-color mode.

FIG. 4 shows block diagrams showing a part inside of the image processing apparatus (a) performing a preview display in the copier mode and the singe-color mode and (b) performing a preview display in the copier mode and the two-color mode.

FIG. 5 shows gamma curves, i.e., (a) an example of a gamma curve corresponding to the display characteristics of an image display device and (b) a solid line representing a gamma curve for texts to be sharply displayed and a dotted line representing a gamma curve corresponding to the display characteristics of the image display device.

FIG. 6 is a flow chart showing steps of a process that is performed by the image forming apparatus in the copier mode and the full-color mode.

FIG. 7 is a block diagram showing the image forming apparatus of the present embodiment and showing the flow of image data in a transmission process in a facsimile transmission mode.

FIG. 8 is a block diagram showing the image forming apparatus of the present embodiment and showing the flow of image data in a preview display process in the facsimile transmission mode.

FIG. 9 is a block diagram showing the image forming apparatus of the present embodiment and showing the flow of image data in a printing process in a facsimile reception mode.

FIG. 10 is a block diagram showing the image forming apparatus of the present embodiment and showing the flow of image data in a preview display process in the facsimile reception mode.

FIG. 11 is a block diagram showing a modification of the image forming apparatus of the present embodiment.

FIG. 12 shows (a) a flow chart showing steps of a process that is performed by a control section of Example 1, (b) a flow chart showing steps of a process that is performed by a segmentation class signal decompression section of Example 2, and (c) a flow chart showing steps of a process that is performed by a segmentation class signal decompression section of Example 3.

### DESCRIPTION OF EMBODIMENTS

### Embodiment 1

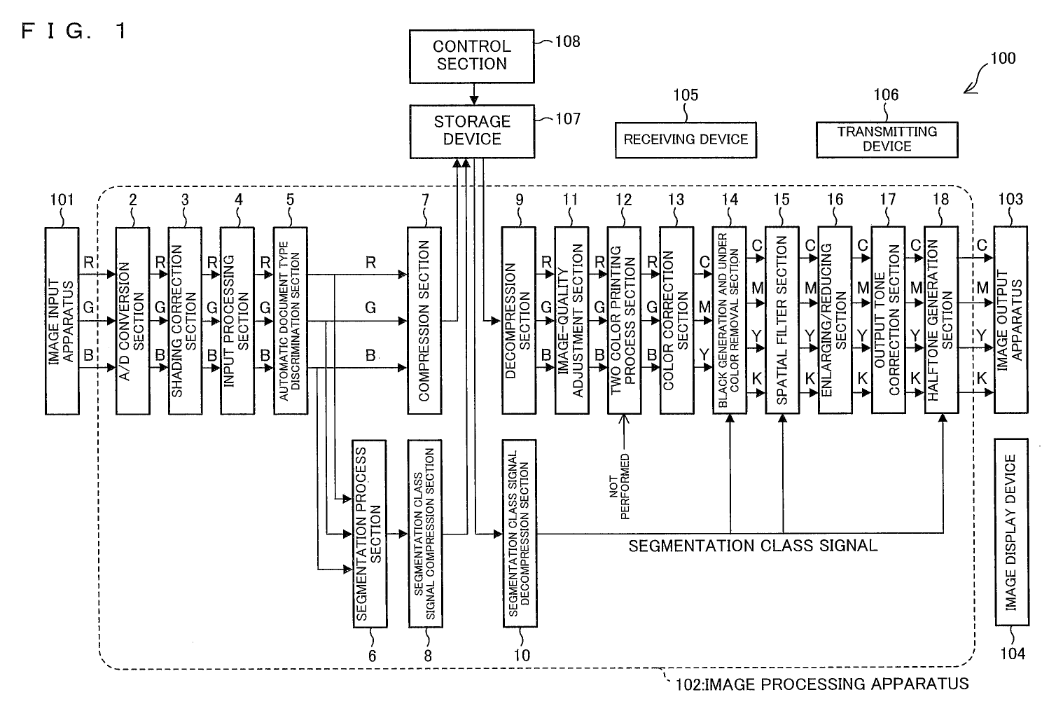

One embodiment of an image forming apparatus of the present invention is described below with reference to the attached drawings. FIG. 1 is a block diagram schematically showing an arrangement of an image forming apparatus 100 of the present embodiment.

The image forming apparatus 100 of the present embodiment is a digital color multifunction printer that executes a mode selected from among a copier mode, a print mode, a facsimile transmission mode, a facsimile reception mode, and an image transmission mode.

The copier mode (copy mode) means a mode in which to read image data (generates image data by scanning a document) and print an image of the image data onto a sheet of paper. The print mode means a mode in which to print, onto a sheet of paper, an image of image data sent from a terminal apparatus connected to the image forming apparatus 100. The facsimile transmission mode means: a normal facsimile mode in which to transmit, to an external apparatus via a telephone line, image data obtained by scanning a document; and an Internet facsimile mode in which to transmit an e-mail with the image data attached thereto. The facsimile reception mode means a mode in which to receive image data from an external apparatus by facsimile and print an image of the received image data onto a sheet of paper. The image transmission mode means: (1) a mode (scan to e-mail mode) in which to attach, to an e-mail, image data generated by scanning a document, and transmit the e-mail to a specified address; (2) a mode (scan to ftp mode) in which to transmit, to a folder specified by a user, image data generated by scanning a document; and (3) a mode (scan to usb mode) in which to transmit, to a USB memory mounted in the image forming apparatus 100, image data generated by scanning a document. It should be noted that the facsimile transmission mode and the image transmission mode are each classified as above according to the type of image processing operation.

Further, in the copier mode or print mode, the user can select a black-and-white mode in which to output a black-and-white image, a full-color mode in which to output a full-color image, a single-color mode in which to output a monochrome image having only one color desired by the user, or a two-color mode in which to output a two-color image having black and one color desired by the user.

For example, in cases where the user selects the single-color mode in the copier mode or print mode, the monochromatic image is printed. Further, in cases where the user selects the two-color mode in the copier mode or print mode, the two-color image is printed. It should be noted that in the single-color mode or two-color mode, the user selects his/her desired color from among R (red), G (green), B (blue), C (cyan), M (magenta), and Y (yellow).

Further, according to the present invention it is possible to set an automatic discrimination mode in the copier mode. In the automatic discrimination mode, the image forming apparatus 100 performs auto color selection (ACS) for judging whether an object to be copied is a color document or a black-and-white document. In the case of a color document, the image forming apparatus 100 performs an output process in the full-color mode. In the case of a black-and-white document, the image forming apparatus 100 performs an output process in the black-and-white mode.

As shown in FIG. 1, the image forming apparatus 100 includes an image input apparatus 101, an image processing apparatus 102, an image output apparatus 103, an image display device 104, a receiving device 105, a transmitting device 106, a storage device 107, and a control section 108.

The image input apparatus 101 is image scanning means for generating image data by scanning a document in the copier mode, the facsimile transmission mode, and the image transmission mode. More specifically, the image input apparatus 101, which includes a scanner section having a CCD (charge-coupled device), converts light reflected by a document into an electrical signal separated into colors RGB (i.e., into an analog image signal) and sends the electrical signal to the image processing apparatus 102.

It should be noted that the image input apparatus 101 scans a document image in full color in any one of the full-color mode, the single-color mode, and the two-color mode. Further, the image input apparatus 101 scans a document image in full color even in cases where the image processing apparatus 102 performs the aforementioned auto color selection.

The image processing apparatus 102 is an integrated circuit, constituted by an ASIC (application specific integrated circuit), which performs image processing on image data (image signals). As shown in FIG. 1, the image processing apparatus 102 includes the following blocks: an A/D (analog/digital) conversion section 2, a shading correction section 3, an input processing section 4, an automatic document type discrimination section 5, a segmentation process section 6, a compression (encode) section 7, a segmentation class signal compression (encode) section 8, a decompression (decode) section 9, a segmentation class signal decompression (decode) section 10, an image-quality adjustment section 11, a two-color printing process section 12, a color correction section 13, a black generation and under color removal section 14, a spatial filter section 15, an enlarging/reducing (zoom process) section 16, an output tone correction section 17, and a halftone generation section 18. Processes that are performed by the blocks of the image processing apparatus 102 will be detailed later.

In the copier mode, facsimile transmission mode, or image transmission mode, the image processing apparatus 102 performs image processing on image data sent from the image input apparatus 101. In the print mode, the image processing apparatus 102 performs image processing on image data transmitted from a terminal apparatus. In the facsimile reception mode, the image processing apparatus 102 performs image processing on image data received from an external apparatus. Then, in the copier mode, print mode, or facsimile reception mode, the image processing apparatus 102 transmits, to the image output apparatus 103, the image data subjected to image processing. In the facsimile transmission mode, the image processing apparatus 102 transmits, to the transmitting device 106, the image data subjected to image processing. Further, in the scan to e-mail mode, which is an image transmission mode, the image processing apparatus 102 transmits, to a mail processing section (not shown), the image data subjected to image processing. In the scan to ftp mode, which is another image transmission mode, the image processing apparatus 102 transmits, to a predetermined folder, the image data subjected to image processing. In the scan to usb mode, which is the other image transmission mode, the image processing apparatus 102 transmits, to a predetermined USB memory, the image data subjected to image processing.

The image output apparatus (printer) 103 forms, onto a recording medium (e.g., a sheet of paper), an image of image data sent from the image processing apparatus 102. An example is an electrophotographic or ink-jet color printer. The term “printing” in the present embodiment means printing in the print mode, printing in the copier mode, or printing in the facsimile reception mode.

The image display device 104 is a liquid crystal display provided in an operation panel (not shown) of the image forming apparatus 100, and is display means capable of displaying a color image. Further, the image display device 104, covered with a touch panel, functions as an input interface of the image forming apparatus 100. That is, the image display device 104 displays a GUI for inputting various commands to the image forming apparatus 100 and an operation guide.

Further, before execution of printing in the copier mode or facsimile reception mode, the image forming apparatus 100 of the present embodiment can display, on the image display device 104, a preview of an image to be printed. Furthermore, before execution of transmission in the facsimile transmission mode or image transmission mode, the image forming apparatus 100 of the present embodiment can display, on the image display device 104, a preview of an image to be transmitted.

Further, in the copier mode or image transmission mode and the full-color mode, the image display device 104 displays a preview of a full-color image. In the copier mode or image transmission mode and the single-color mode, the image display device 104 displays a preview of a monochrome image. In the copier mode or image transmission mode and the two-color mode, the image display device 104 displays a preview of a two-color image.

The image display device 104 is not limited to the liquid crystal display, and may be display means other than the liquid crystal display (e.g., an organic EL display or a plasma display).

The receiving device 105 is a device, connected to a telephone line or the Internet, which receives image data from an external apparatus by facsimile communication. Further, the transmitting device 106 is a device, connected to a telephone line or the Internet, which transmits, to an external apparatus by facsimile communication, image data inputted to the image input apparatus 101.

The storage device 107 is a hard disk in which image data to be processed in the image processing apparatus 102 is temporarily stored.

The control section 108 is a computer including a processor such as a CPU (central processing unit) or a DSP (digital signal processor), and comprehensively controls various types of hardware provided in the image forming apparatus 100. Further, the control section 108 functions to control data transfer between pieces of hardware provided in the image forming apparatus 100.

The following details the processes that are executed by the blocks of the image processing apparatus 102 in the copier mode, the facsimile transmission mode, the facsimile reception mode, and the image transmission mode, respectively. It should be noted that the image processing apparatus 102 of the present embodiment has a block that operates while a mode a is being used but does not operate while a mode b different from the mode a is being used (the mode a and the mode b each being any one of the copier mode, the facsimile transmission mode, the facsimile reception mode, and the image transmission mode). Further, the image processing apparatus 102 has a block that varies in processing according to the mode being used. Furthermore, the image processing apparatus 102 has: a block that, even in the same mode, operates in processing of image data to be printed (transmitted) but does not operate in processing of image data to be previewed; and a block that, even in the same mode, varies between processing of image data to be printed (transmitted) and processing of image data to be previewed. In the following, therefore, the processes that are executed by the blocks of the image processing apparatus 102 are described according to the type of mode, and those processes which are executed in a printing process (or in a transmission process) and those processes which are executed at the time of a preview display are described separately.

(1) Copier Mode

(1-1) Printing Process (Image Print Job)

In the following, the image processing apparatus 102 is described with reference to FIG. 1, which shows the flow of image data in the image processing apparatus 102 performing a printing process in the copier mode and the full-color mode.

The A/D (analog/digital) conversion section 2 is a block that receives color image signals (RGB analog signals) from the image input apparatus 101 and converts the color image signals into digital image data (RGB digital signals). The shading correction section 3 is a block that receives image data form the A/D conversion section 2 and subjects the image data to a process of removing various distortions generated in illuminating, image-focusing, and image-sensing systems of the image input apparatus 101. The input processing section 4 is a block that receives RGB image data from the shading correction section 3 and subjects each of the RGB image data to a tone conversion process such as a gamma correction process.

In accordance with RGB image data (RGB density signals) subjected to processing such as gamma correction in the input processing section 4, the automatic document type discrimination section 5 discriminates among types of documents scanned by the image input apparatus 101. It should be noted here that the types of documents among which the automatic document type discrimination section 5 discriminates are a text document, a printed-picture document, a text/printed-picture document containing a text and a printed picture together, and the like. Further, in accordance with the image data, the automatic document type discrimination section 5 can perform auto color selection (ACS) for judging whether a scanned document is a color document or a black-and-white document and a process for judging whether or not a scanned document is a blank document (a solid-color document). It should be noted that the automatic document type discrimination section 5 sends the RGB image data to the segmentation process section 6 and the compression section 7.

In accordance with the RGB image data sent from the automatic document type discrimination section 5, the segmentation process section 6 performs a process of judging, for each pixel of the input image, what image area the pixel is classified into and generating a segmentation class signal indicating a result of the judgment. It should be noted here that the types of image areas among which the segmentation process section 6 discriminates are a black text area, a color text area, a halftone dot area, and the like. The segmentation process may take the form of a process of judging, for each block of pixels, what image area the block is classified into, instead of taking the form of a process of judging, for each pixel, what image area the pixel is classified into.

The compression section 7 is a block that performs a process of encoding image data (RGB signals) sent from the automatic document type discrimination section 5. The encoding is performed, for example, based on JPEG (Joint Photographic Experts Group).

The segmentation class signal compression section 8 is a block that performs a compression (encode) process on a segmentation class signal generated for each pixel. The compression process in the segmentation class signal compression section 8 is performed, for example, based on MMR (Modified Modified Reed) or MR (Modified Reed), which is a lossless compression technology.

The control section 108 receives encoded codes (encoded image data) from the compression section 7 and segmentation class signal codes (encoded segmentation class signals) from the segmentation class signal compression section 8, stores them temporarily in the storage device 107, and manages them as filing data. Then, in response to an instruction for a copy output operation, the control section 108 reads out, from the storage device 107, an encoded code and a segmentation class signal code corresponding to the encoded code, and sends them to the decompression section 9 and the segmentation class signal decompression section 10, respectively.

The control section 108 writes the storage address or data name of the encoded code and the storage address of the segmentation class signal code in a management table in association with each other. That is, the control section 108 controls reading or writing of encoded codes and segmentation class signal codes with reference to the management table.

The decompression section 9 decompresses the encoded code into RGB image data by performing a decompression (decode) process on the encoded code. Further, the segmentation class signal decompression section 10 performs a decompression process on the segmentation class signal code. The resulting segmentation class signal is sent to the black generation and under color removal section 14, the spatial filter section 15, and the halftone generation section 18. Then, the black generation and under color removal section 14, the spatial filter section 15, and the halftone generation section 18 select image processing according to the type of image area.

The image-quality adjustment section 11 receives the RGB image data from the decompression section 9, and performs background removal correction on the RGB image data by detecting a background in the RGB image data. Furthermore, the image-quality adjustment section 11 adjusts RGB balance (color adjustment of red, green, or blue), brightness, and intensity (saturation) in accordance with configuration information inputted by the user from the operation panel (not shown).

Furthermore, in the single-color mode, the image-quality adjustment section 11 converts the RGB image data into CMY image data complementary to the RGB image data. It should be noted here that the conversion of the RGB data into the CMY image data in the single-color mode is executed by using Eq. (1) below, where the coefficients r1 to r3 are defined based on [Table 1]. For example, in cases where the user selects cyan as his/her desired color in the single-color mode, the values of r1 to r3 in the column “Cyan” are referred to, with the result that r1=1, r2=0, and r3=0 are selected.

TABLE 1

| | | | | | | Eq. (1) |
|---|---|---|---|---|---|---|
| $( \begin{matrix}C \\ M \\ Y\end{matrix} ) = ( \begin{matrix}r 1 \cdot a 1 & r 1 \cdot a 2 & r 1 \cdot a 3 \\ r 2 \cdot a 1 & r 2 \cdot a 2 & r 2 \cdot a 3 \\ r 3 \cdot a 1 & r 3 \cdot a 2 & r 3 \cdot a 3\end{matrix} ) \times ( \begin{matrix}R \\ G \\ B\end{matrix} ) + ( \begin{matrix}r 1 \cdot c \\ r 2 \cdot c \\ r 3 \cdot c\end{matrix} )$ | | | | | | |
| Adjustment | Output Color (Single Color) | | | | | |
| Plane | Red | Green | Blue | Cyan | Magenta | Yellow |
| r1 | 0 | 1 | 1 | 1 | 0 | 0 |
| r2 | 1 | 0 | 1 | 0 | 1 | 0 |
| r3 | 1 | 1 | 0 | 0 | 0 | 1 |

a1 = −0.23046875
a2 = −0.79296875
a3 = 0.0234375
c = 255

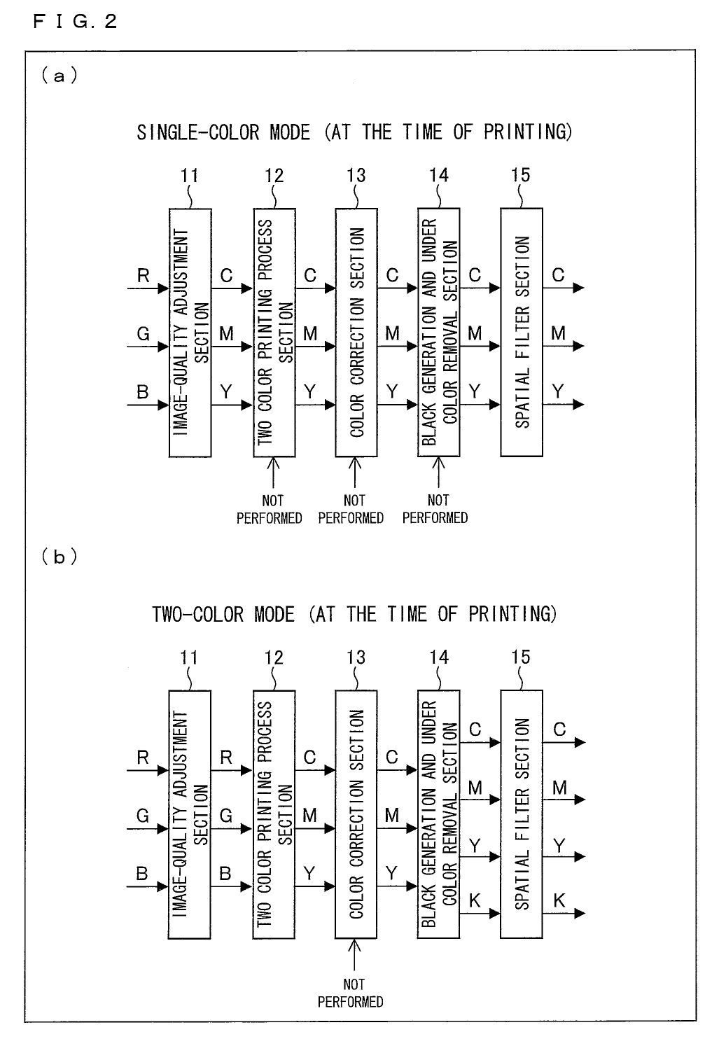

That is, whereas the output from the image-quality adjustment section 11 in the full-color mode is RGB image data as shown in FIG. 1, the output from the image-quality adjustment section 11 in the single-color mode is CMY image data as shown in (a) of FIG. 2. It should be noted that the output from the image-quality adjustment section 11 in the two-color mode is RGB image data as shown in (b) of FIG. 2. (a) of FIG. 2 shows some of the blocks of the image processing apparatus 102 performing a printing process in the copier mode and the single-color mode, and (b) of FIG. 2 shows some of the blocks of the image processing apparatus 102 performing a printing process in the copier mode and the two-color mode.

Further, the adjustment of intensity by the image-quality adjustment section 11 can be realized by using the matrix of Eq. (1) after varying the values of r1 to r3and a1 to a3 of the matrix. This makes it possible to use the same matrix and the same image processing circuit for the adjustment of intensity and the conversion of image data (from RGB into CMY) in the single-color mode. Therefore, in the present embodiment, the adjustment of intensity and the conversion of image data in the single-color mode are performed by the same processing section (image-quality adjustment section 11).

The two-color printing process section 12 is a block that, in the two color mode, receives RGB image data from the image-quality adjustment section 11 and converts the RGB image into CMY image data as shown in (b) of FIG. 2. The conversion of the RGB image data into the CMY image data in the two-color mode can be realized, for example, by a technique of [Embodiment 1] or [Embodiment 2] described in Japanese Patent Application Publication, Tokukai, No. 2007-28336 A.

Further, in the full-color mode, as shown in FIG. 1, the two-color printing process section 12 performs no processing on the image data sent from the image-quality adjustment section 11 and passes the image data directly on to the color correction section 13. Furthermore, in the single-color mode, as shown in (a) of FIG. 2, two-color printing process section 12 performs no processing on the CMY image data sent from the image-quality adjustment section 11 and passes the image data directly on to the color correction section 13.

The color correction section 13 is a block that, in the full-color mode, receives RGB image data from the two-color printing process section 12, performs a color correction process of converting the RGB image data into CMY image data, and performs a process of improving the color reproducibility of the image data. The color correction process is realized by creating an LUT (look-up table) of input values (RGB) and output values (CMY) associated with one another and looking up the output values in the created LUT.

Further, in the single-color mode or two-color mode, as shown in FIG. 2, the color correction section 13 performs no processing on the CMY image data sent from the two-color printing process section 12 and passes the image data directly on to the black generation and under color removal section 14.

The black generation and under color removal section 14 is a block that, in the full-color mode or two-color mode, receives CMY image data from the color correction section 13, generates black (K) image data from the CMY image data, and generate new CMY image data by subtracting the black (K) image data from the original CMY image data. Thus, in the full-color mode or two-color mode, as shown in FIG. 1 or (b) of FIG. 2, the black generation and under color removal section 14 converts the CMY image data into four colors of image data CMYK.

Further, in the single-color mode, as shown in (a) of FIG. 2, the black generation and under color removal section 14 performs no processing on the CMY image data sent from the color correction section 13 and passes the image data directly on to the subsequent spatial filter section 15.

In the full-color mode or two-color mode, the output from the black generation and under color removal section 14 and the input to and output from each block subsequent to the black generation and under color removal section 14 are CMYK image data as shown in FIG. 1. Meanwhile, in the single-color mode, the output from the black generation and under color removal section 14 and the input to and output from each block subsequent to the black generation and under color removal section 14 are CMY image data unlike in FIG. 1.

The spatial filter section 15 receives the CMYK or CMY image data from the black generation and under color removal section 14 and performs a spatial filter process (e.g., edge enhancement process, smoothing process) on the image data by a digital filter in accordance with the segmentation class signals. That is, the spatial filter section 15 executes image processing differently for each image area in accordance with the segmentation class signals.

The enlarging/reducing section 16 is a block that enlarges or reduces an image in accordance with an enlarging/reducing command (information indicating the zoom ratio of a printed image) inputted by the user from the operation panel (not shown).

The output tone correction section 17 is a block that receives image data from the enlarging/reducing section 16 and performs output gamma correction for outputting the image data onto a recording medium such as a sheet of paper. The halftone generation section 18 executes, by dithering or error diffusion, a tone reproduction process (halftone generation process) necessary for the image output apparatus 103 to print an image.

Then, the halftone generation section 18 passes the CMYK or CMY image data on to the image output apparatus 103, and the image output apparatus 103 prints an image of the image data onto a recording medium (e.g., a sheet of paper).

(1-2) Preview Display

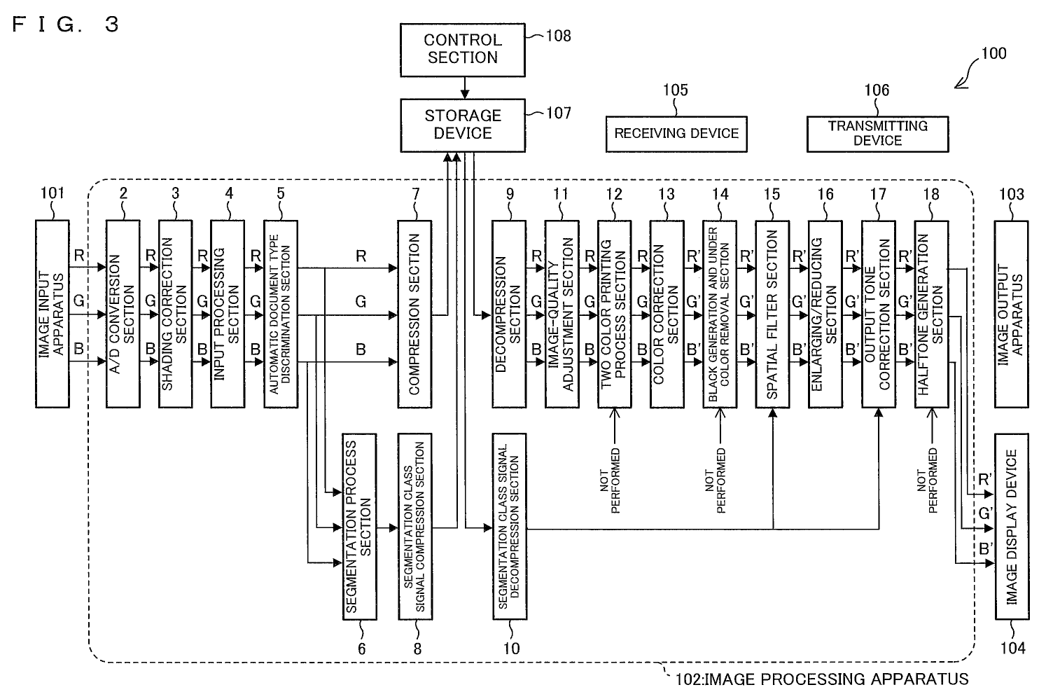

Next, the processes that are executed by the blocks of the image processing apparatus 102 in cases where a preview of an image to be printed is displayed in the copier mode are described with reference to FIG. 3. FIG. 3 is a block diagram showing the same image forming apparatus 100 as in FIG. 1 and showing the flow of image data at the time of a preview display process in the copier mode and the full-color mode.

It should be noted that because the A/D (analog/digital) conversion section 2, the shading correction section 3, the input processing section 4, the automatic document type discrimination section 5, the segmentation process section 6, the compression section 7, the segmentation class signal compression section 8, the decompression section 9, the image-quality adjustment section 11, and the two-color printing process section 12 perform the same processes as in the case of a printing process, such processes will not be described below.

At the time of a preview display, as shown in FIG. 3, the segmentation class signal decompression section 10 decompresses (decodes) segmentation class signals and passes them on to the spatial filter section 15 and the output tone correction section 17.

In the full-color mode, the color correction section 13 receives RGB image data in color space of the scanner (image input apparatus 101). Then, the color correction section 13 converts the RGB image data into R′G′B′ image data in color space of the image display device 104.

That is, the color correction section 13 converts the RGB image data, which conform to the image scanning characteristics of the scanner, into the R′G′B′ image data, which conform to the display characteristics of the display device. It should be noted that the conversion of the RGB image data into the R′G′B′ image data is also realized by creating an LUT (look-up table) of input values (RGB) and output values (R′G′B′) associated with one another and looking up the output values in the created LUT.

Moreover, in the full-color mode, the present embodiment uses the same image processing circuit for the conversion of RGB image data into CMYK image data at the time of a printing process and the conversion of RGB image data into R′G′B′ image data at the time of a preview display.

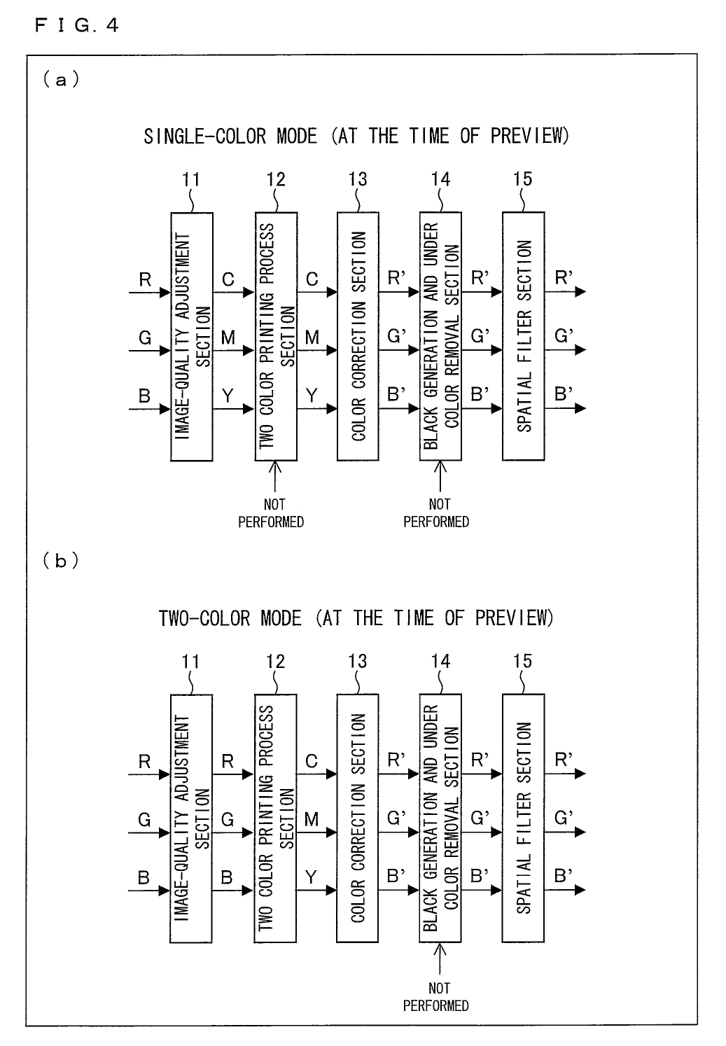

As with FIG. 1, FIG. 3 shows the image forming apparatus 100 in the full-color mode. In the full-color mode, the color correction section 13 receives RGB image data. Meanwhile, in the single-color mode or two-color mode, as shown in FIG. 4, the color correction section 13 receives CMY image data. (a) of FIG. 4 shows some blocks of the image processing apparatus 2 performing a preview display in the copier mode and the singe-color mode, and (b) of FIG. 4 shows some blocks of the image processing apparatus performing a preview display in the copier mode and the two-color mode.

Then, in the single-color mode or two-color mode, the color correction section 13 converts the CMY image data into R′G′B′ image data. That is, the color correction section 13 converts the CMY image data, which conform to the printing characteristics of the printing process, into the R′G′B′ image data, which conform to the display characteristics of the display device. It should be noted that the conversion of the CMY image data into the R′G′B′ image data is also realized by creating an LUT (look-up table) of input values (RGB) and output values (R′G′B′) associated with one another and looking up the output values in the created LUT.

In any one of the single-color mode, the two-color mode, and the full-color mode, as shown in FIGS. 3 and 4, the black generation and under color removal section 14 performs no processing on the R′G′B′ image data sent from the color correction section 13 and passes the image data directly on to the subsequent spatial filter section 15.

The spatial filter section 15 receives the R′G′B′ image data from the black generation and under color removal section 14 and performs a spatial filter process (e.g., edge enhancement process, smoothing process) on the image data by a digital filter in accordance with the segmentation class signals. That is, as in the case of a printing process, the spatial filter section 15 executes image processing differently for each image area in accordance with the segmentation class signals.

The enlarging/reducing section 16 performs a downsampling process by which the number of pixels of an image composed of the R′G′B′ image data sent from the spatial filter section 15 is converted into the number of pixels of the image display device 104 (process by which the number of pixels is reduced). The image display device 104, provided in the operation panel of the image forming apparatus 100, is lower in resolution than image data to be printed and, usually, is an extremely small display. Therefore, at the time of a preview display, it is necessary to downsample the image data. Further, the enlarging/reducing section 16 enlarges or reduces the image in accordance with an enlarging/reducing command (information indicating the zoom ratio of a display, e.g., a fixed zoom ratio of 2 to 4 times) inputted from the operation panel (not illustrated) provided in the image forming apparatus.

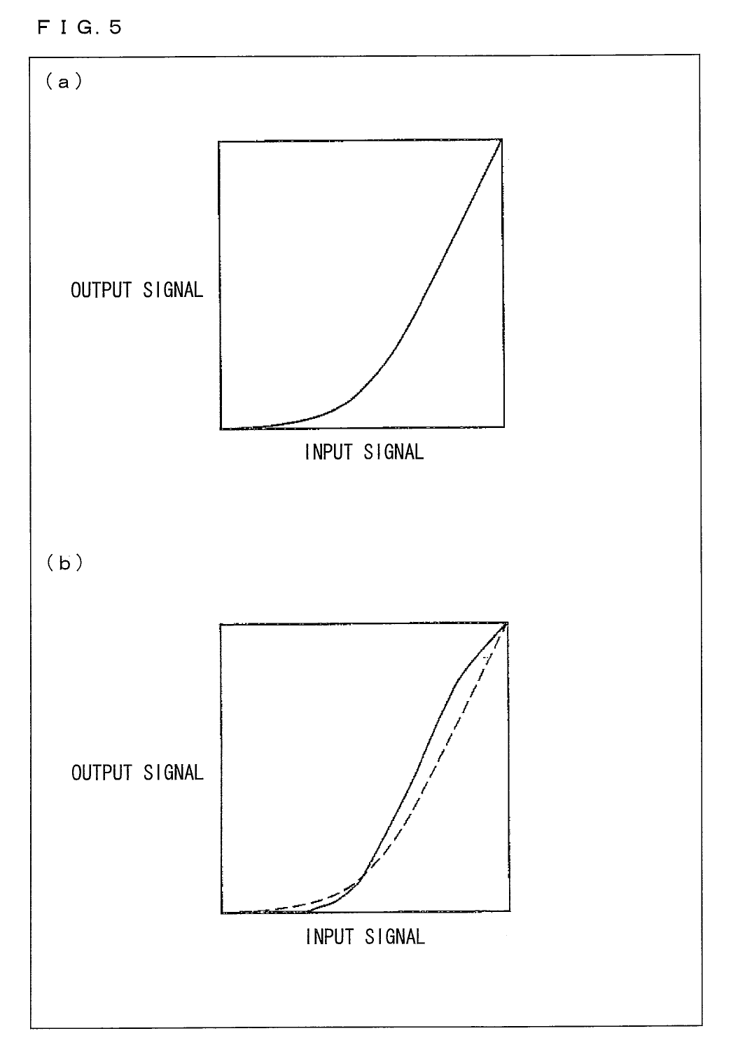

The output tone correction section 17 receives the image data from the enlarging/reducing section 16 and performs output gamma correction on the image data in accordance with the segmentation class signals. More specifically, in accordance with the segmentation class signals, the output tone correction section 17 selects different gamma curves for different image areas and varies in output gamma correction from one image area to another. For example, for nontext areas, the output tone correction section 17 selects a gamma curve corresponding to the display characteristics of the image display device 104, and for text areas, selects a gamma curve for texts to be sharply displayed. (a) of FIG. 5 shows a gamma curve corresponding to the display characteristics of the image display device 104, and (b) of FIG. 5 shows a solid line representing a gamma curve for texts to be sharply displayed and a dotted line representing a gamma curve corresponding to the display characteristics of the image display device 14. The dotted line is shown for comparison with the gamma curve for texts to be sharply displayed.

In the present embodiment, the output tone correction section 17 selects between the gamma curves in accordance with the segmentation class signals. However, the output tone correction section 17 may perform output tone correction by using only the gamma curve of (a) of FIG. 5, instead of making selection in accordance with the segmentation class signals.

Then, the halftone generation section 18 performs no processing on the R′G′B′ image data sent from the output tone correction section 17 and passes the image data directly on to the subsequent image display device 104. This allows the image display device 104 to display, in accordance with the R′G′B′ image data, a preview of an image to be copied.

It should be noted that in place of the output tone correction section 17, the image-quality adjustment section 11 may execute output gamma correction.

(1-3) As to Whether the Blocks Operate or Do Not Operate

As described above, at the time of printing in the full-color mode, the image-quality adjustment section 11 through the halftone generation section 18 all operate except for the two-color printing process section 12 (see FIG. 1). Meanwhile, at the time of a preview display in the full-color mode, the image-quality adjustment section 11 through the halftone generation section 18 all operate except for the two-color printing process section 12, the black generation and under color removal section 14, and the halftone generation section 18 (see FIG. 3).

Further, at the time of printing in the two-color mode, the image-quality adjustment section 11 through the halftone generation section 18 all operate except for the color correction section 13 (see (b) of FIG. 2). Meanwhile, at the time of a preview display in the two-color mode, the image-quality adjustment section 11 through the halftone generation section 18 all operate except for the black generation and under color removal section 14 and the halftone generation section 18 (see (b) of FIG. 4).

Furthermore, at the time of printing in the single-color mode, the image-quality adjustment section 11 through the halftone generation section 18 all operate except for the two-color printing process section 12, the color correction section 13, and the black generation and under color removal section 14 (see (a) of FIG. 2). Meanwhile, at the time of a preview display in the single-color mode, the image-quality adjustment section 11 through the halftone generation section 18 all operate except for the two-color printing process section 12, the black generation and under color removal section 14, and the halftone generation section 18 (see (a) of FIG. 4).

(1-4) Steps of a Process

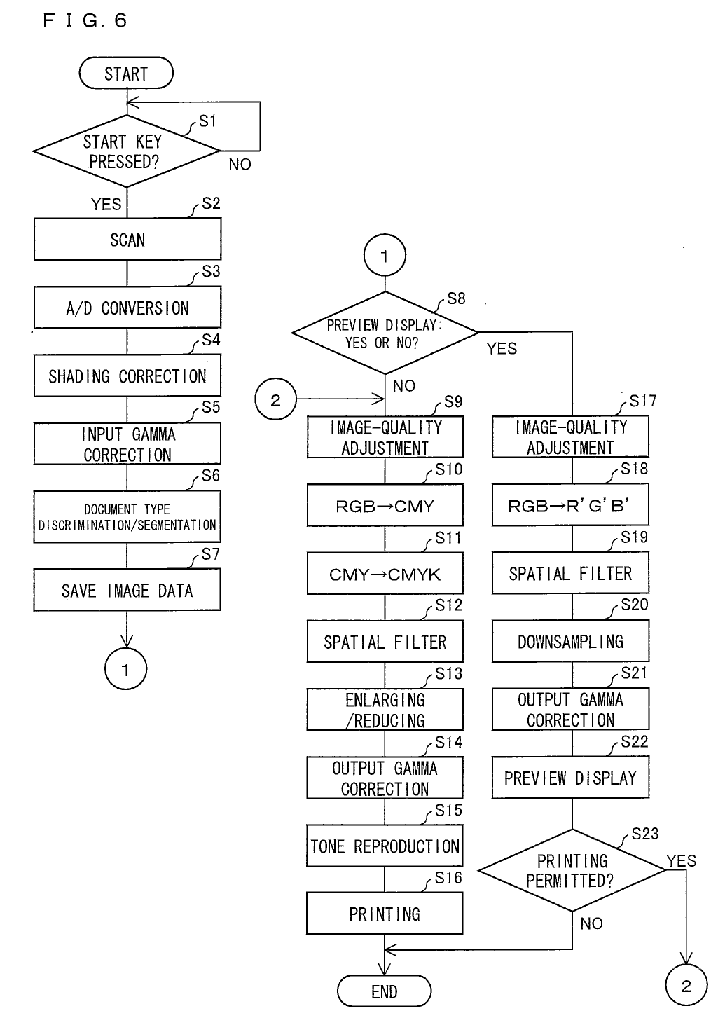

Next, an example of steps of a process in the copier mode and the full-color mode is described with reference to FIG. 6. FIG. 6 is a flow chart showing an example of steps of a process that is performed by the image forming apparatus in the copier mode and the full-color mode.

In response to a pressing of a start key (YES in S1) in the copier mode, the image forming apparatus 100 generates RGB analog signals by scanning a document (S2). It is assumed here that prior to the pressing of the start key in S1, the user inputs setting information indicating whether or not a preview display is necessary and thereby sets whether or not the image forming apparatus 100 performs a preview display.

After S2, the image forming apparatus 100 converts the RGB analog signals into RGB image data (digital data) (S3), subjects the RGB image data to shading correction (S4), and then subjects the RGB image data to input gamma correction (S5). After S5, the image forming apparatus 100 performs a document type discrimination process and a segmentation process in accordance with the RGB image data (S6), and then stores the RGB image in the storage device 107 (S7).

After S7, the image forming apparatus 100 judges whether or not it has been set to “Preview Display: Yes” (S8). In cases where it has not been set to “Preview Display: Yes”, the image forming apparatus 100 executes Steps S9 through S16. In cases where it has been set to “Preview Display: Yes”, the image forming apparatus 100 executes Steps S17 through S23. In the following, Steps S9 through S16 are described first, and then Steps S17 through S23 are described.

In cases where the image forming apparatus 100 has not been set to “Preview Display: Yes” (NO in S8), the image forming apparatus 100 reads out the RGB image data from the storage device 107, and then performs an image-quality adjustment process such as background removal correction and adjustment of intensity (S9). After that, the image forming apparatus 100 converts the RGB image data, which conforms to the characteristics of the scanner, into CMY image data conforming to the characteristics of the printer (S10), and then converts the CMY image data into CMYK image data (S11). After that, the image forming apparatus 100 performs a spatial filter process on the CMYK image data in accordance with a result of the segmentation process (S12), and then performs an enlarging/reducing process on the CMYK image data (S13). After S13, the image forming apparatus 100 performs output gamma correction and a tone reproduction process on the CMYK image data (S14, S15), prints an image of the image data on a sheet of paper (S16), and then finishes the process.

In cases where the image forming apparatus 100 judges, in S8, that it has been set to “Preview Display: Yes” (YES in S8), the image forming apparatus 100 reads out the RGB image data from the storage device 107, and then performs the same image-quality adjustment process as in S9 (S17). After that, the image forming apparatus 100 converts the RGB image data, which conforms to the characteristics of the scanner, into R′G′B′ image data conforming to the characteristics of the display device (S18). After S18, the image forming apparatus 100 performs a spatial filter process on the R′G′B′ image data in accordance with a result of the segmentation process (S19), and then performs a downsampling process on the R′G′B′ image data so that the R′G′B′ image data conforms to the resolution and size of the display (S20). After S20, the image forming apparatus 100 performs output gamma correction on the R′G′B′ image data in accordance with the result of the segmentation process (S21). After S21, the image forming apparatus 100 performs a preview display in accordance with the R′G′B′ image data (S22). Then, after S22, upon receiving, from the user, a command indicating permission of printing (YES in S23), the image forming apparatus 100 again reads out the RGB image data from the storage device 107, and then performs printing by executing Steps S9 through S16 in accordance with the image data. On the other hand, after S22, upon receiving, from the user, a command indicating cancellation of printing (NO in S23), the image forming apparatus 100 finishes the process.

(2) Facsimile Transmission Mode

(2-1) Transmission Process (Image Transmission Job)

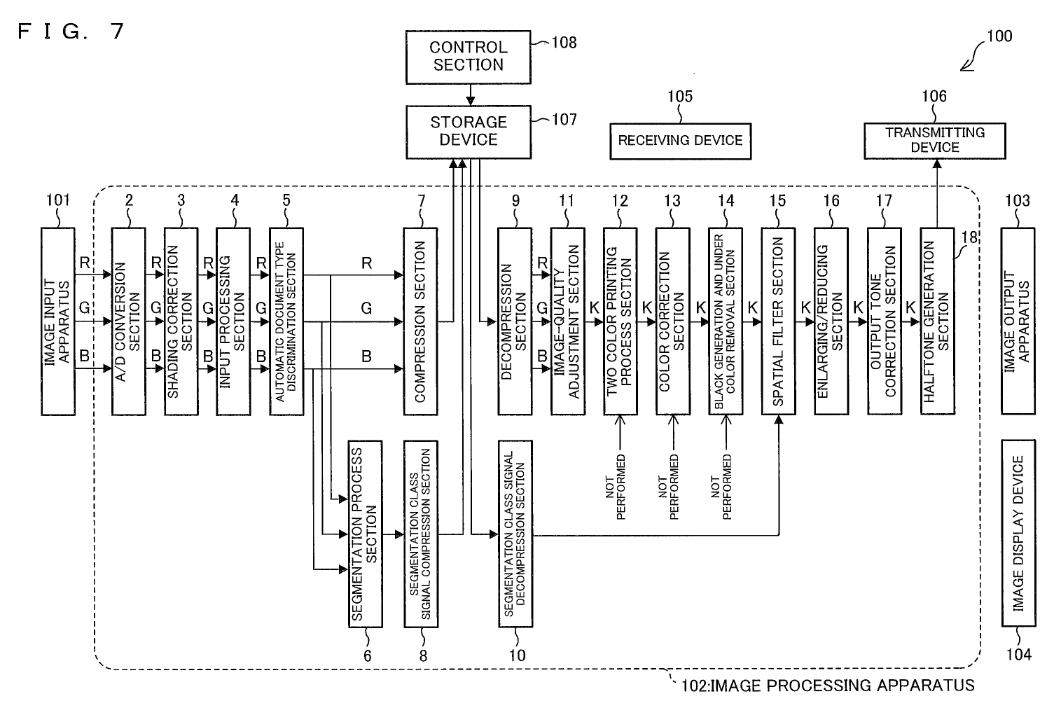

FIG. 7 is a block diagram showing the same image forming apparatus 100 as in FIG. 1 and showing the flow of image data in a transmission process in the facsimile transmission mode. It should be noted that because the A/D (analog/digital) conversion section 2, the shading process section 3, the input processing section 4, the automatic document type discrimination section 5, the segmentation process section 6, the compression section 7, the segmentation class signal compression section 8, and the decompression section 9 performs the same processes as in the case of the copier mode, such processes will not be described below.

In the facsimile transmission mode, the segmentation class signal decompression section 10 reads out the segmentation class signal codes from the storage device 107, decompresses the segmentation class signal codes, and then transmits the decompressed (decoded) segmentation class signal codes to the spatial filter section 15.

The image-quality adjustment section 11 receives the RGB image data from the decompression section 9 and converts the RGB image into K image data (a value indicating grayscale). It should be noted that this conversion is performed by using a predetermined matrix of coefficients and Eq. (2) below:

Luminance(Value of K Image Data)=0.299r+0.587g+0.114b Eq. (2)

where r is the value (density) of red image data, g is the value of green image data, and b is the value of blue image data.

The two-color printing process section 12, the color correction section 13, and the black generation and under color removal section 14 perform no processing on the K image data (signal) sent from the image-quality adjustment section 11 and pass the K image data directly on to the subsequent spatial filter section 15.

The spatial filter section 15 performs a spatial filter process (e.g., edge enhancement process, smoothing process) on the K image data by a digital filter in accordance with the segmentation class signals. The enlarging/reducing section 16 performs an enlarging/reducing process on the K image data in accordance with the transmission resolution. The output tone correction section 17 performs output gamma correction (gamma correction for output onto a recording medium such as a sheet of paper) on the K image data sent from the enlarging/reducing section 16. The halftone generation section 18 converts the K image data into binarized image data, for example, by error diffusion. Then, the binarized image data are rotated by a rotation process section (not shown) as needed, compressed by a compression/decompression section (not shown) into a predetermined form, and then stored in a memory (not shown).

After that, the transmitting device (e.g., modem) 106 performs a procedure for transmission to the destination and ensures transmittability to the destination. Then, the transmitting device 106 reads out the binarized image data, stored in the memory, with the binarized image data compressed in the predetermined form, subjects the binarized image data to necessary processes such as a conversion in compression format, and then transmits the binarized image data in sequence via a communication line.

(2-2) Preview Display

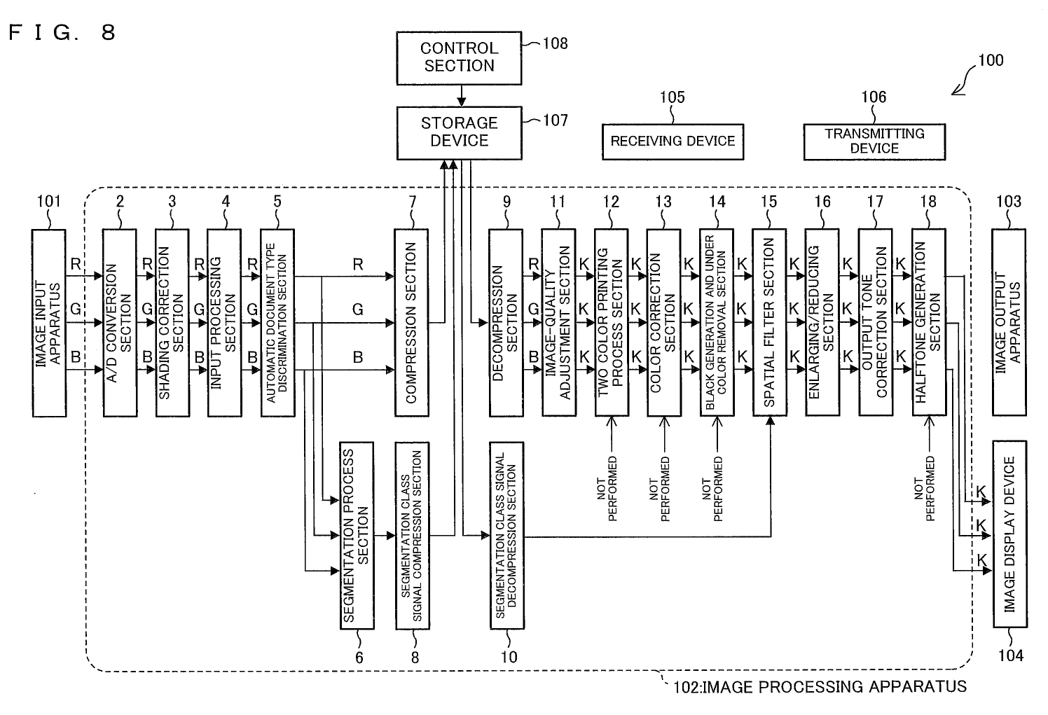

FIG. 8 is a block diagram showing the same image forming apparatus 100 as in FIG. 1 and showing the flow of image data in a preview display process in the facsimile transmission mode. The term “preview display in the facsimile transmission mode” here means a process of displaying a preview of an image to be transmitted by facsimile.

At the time of a preview display, the A/D conversion section 2, the shading correction section 3, the input processing section 4, the automatic document type discrimination section 5, the segmentation process section 6. the compression section 7, the segmentation class signal compression section 8, the decompression section 9, the segmentation class signal decompression section 10, the image-quality adjustment section 11, and the spatial filter section 15 perform the same processes as in the case of a facsimile transmission process; therefore, such processes are not described. Further, as in the case of a facsimile transmission process, the two-color printing process section 12, the color correction section 13, and the black generation and under color removal section 14 do not perform any processes.

However, at the time of a preview display, unlike in the case of a transmission process, as shown in FIG. 8, three pieces of K image data (all being equal in value) are transmitted for each pixel all the way from the image-quality adjustment section 11 to the image display device 104. This is because the image display device 104 is a full-color model and as such requires three values (pieces of image data) for one pixel.

The enlarging/reducing section 16 performs a downsampling process on the K image data so that the number of pixels of an image composed of the K image data sent from the spatial filter section 15 conforms to the number of pixels of the display size of the image display device 104. Further, the enlarging/reducing section 16 enlarges or reduces the image in accordance with an enlarging/ reducing command (information indication the zoom ratio of a display, e.g., a fixed zoom ratio of 2 to 4 times) inputted from the operation panel (not shown) provided in the image forming apparatus 100.

The output tone correction section 17 receives the K image data from the enlarging/reducing section 16 and performs gamma correction on the K image data in conformity to the display characteristics of the image display device 104. Then, the halftone generation section 18 performs no processing on the K image data sent from the output tone correction section 17 and passes the K image data directly on to the subsequence image display device 104. This allows the image display device 104 to display, in accordance with the K image data, a preview of an image to be transmitted by facsimile.

Further, at the time of a preview display process in the facsimile transmission mode, the image-quality adjustment section 11 converts the RGB image data into three pieces of K image data. However, there is no such limitation in embodiment. For example, it is possible to perform image processing without converting RGB image data into K image data up to the output tone correction section 17, to receive the RGB image data from the output tone correction section 17, and to convert the RGB image data into K image data by a browser.

(2-3) As to Whether the Blocks Operate or Do Not Operate

As described above, at the time of a transmission process in the facsimile transmission mode, the image-quality adjustment section 11 through the halftone generation section 18 all operate except for the two-color printing process section 12, the color correction section 13, and the black generation and under color removal section 14 (see FIG. 7). Meanwhile, at the time of a preview display in the facsimile transmission mode, the image-quality adjustment section 11 through the halftone generation section 18 all operate except for the two-color printing process section 12, the color correction section 13, the black generation and under color removal section 14, and the halftone generation section 18 (see FIG. 8).

(2-4) Steps of a Process

Next, an example of steps of a process in the facsimile transmission mode is described. In cases where the image forming apparatus 100 receives a fax transmission command from the user with the image forming apparatus 100 having not been set to “Preview Display: Yes”, the image forming apparatus 100 processes image data as shown in FIG. 7 and transmits the image data to an external apparatus.

Meanwhile, in cases where the image forming apparatus 100 receives a fax transmission command from the user with the image forming apparatus 100 set to “Preview Display: Yes”, the image forming apparatus 100 processes image data as shown in FIG. 8, thereby storing the image data in the storage device 107 and displaying a preview of an image of the image data on the image display device 104. Then, when the image forming apparatus 100 receives a transmission permission command from the user with the preview being displayed, the image forming apparatus 100 reads out the image data from the storage device 107, processes the image data in the decompression section 9 through the halftone generation section 18 as shown in FIG. 7, and transmits the image data to an external apparatus via the transmitting device 106.

(3) Facsimile Reception Mode

(3-1) Printing Process (Image Print Job)

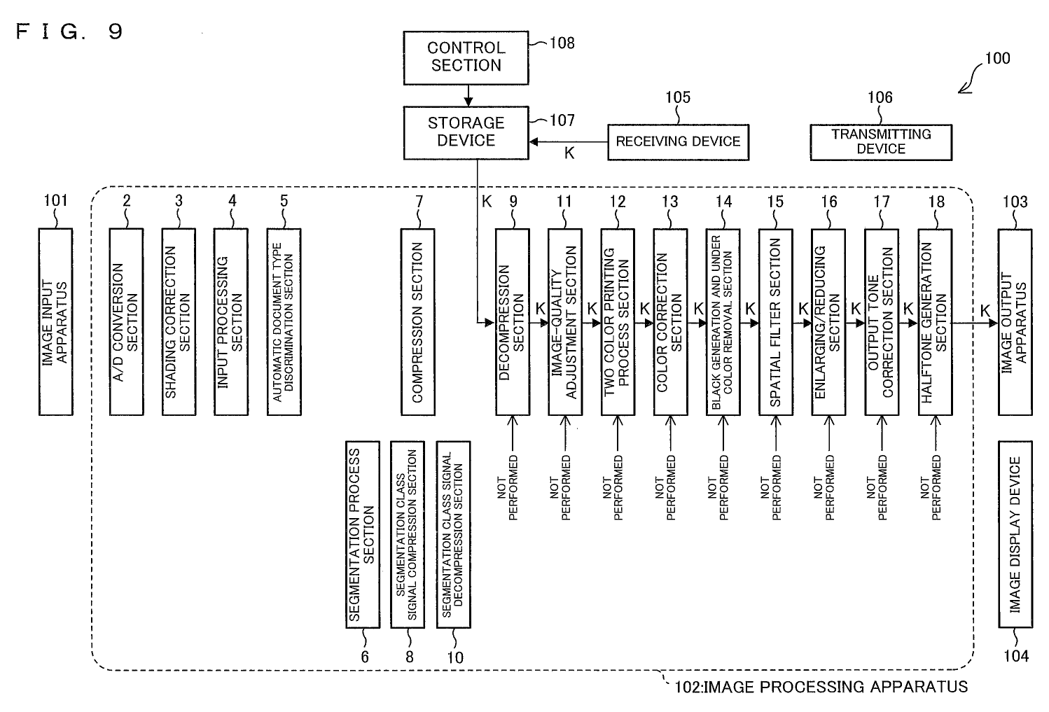

FIG. 9 is a block diagram showing the same image forming apparatus 100 as in FIG. 1 and showing the flow of image data in a printing process in the facsimile reception mode.

In the case of facsimile reception, the receiving device 105 receives K image data (1 bit) from the source while performing a communication procedure. Then, the K image data received by the receiving device 105 are decompressed by the compression/decompression section (not shown), rotated by the rotation process section (not shown) as needed, and then subjected to a resolution conversion process by a resolution conversion section (not shown). After that, the image data are stored temporarily in the storage device 107.

Furthermore, the image data written in the storage device 107 are passed on to the decompression section 9 of the image processing apparatus 102 by the control section 108. The decompression section 9, the image-quality adjustment section 11, the two-color printing process section 12, the color correction section 13, the black generation and under color removal section 14, the spatial filter section 15, the enlarging/reducing section 16, the output tone correction section 17, and the halftone generation section 18 perform no processing on the image data sent from the storage device 107 and pass the image data directly onto the subsequent image output apparatus 103. The image output apparatus 103 forms an image on a recording medium (e.g., a sheet of paper) in accordance with the K image data sent from the halftone generation section 18. In the case of a printing process in the facsimile reception mode, image processing is not performed as described above. Therefore, the image data stored in the storage device 107 may be outputted directly to the image output apparatus 103.

(3-2) Preview Display

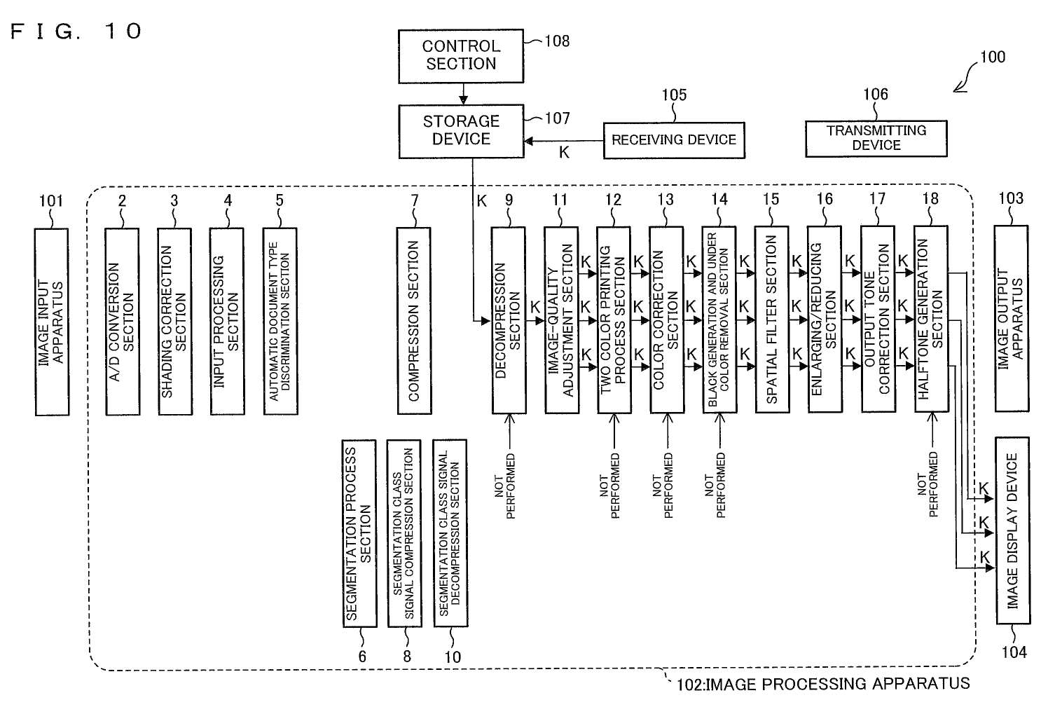

FIG. 10 is a block diagram showing the same image forming apparatus 100 as in FIG. 1 and showing the flow of image data in a preview display process in the facsimile reception mode. The term “preview display in the facsimile reception mode” here means a process of, before printing an image of image data received by facsimile, displaying a preview of the image to be printed.

Also at the time of a preview display in the facsimile reception mode, as in the case of a printing process in the facsimile reception mode, the image data written in the storage device 107 are passed on to the decompression section 9 of the image processing apparatus 102 by the control section 108. The decompression section 9 performs no processing on the image data sent from the storage device 107 and passes the image data on to a bit-number conversion process section (not shown). Then, the bit-number conversion process section converts the number of bits of the image data sent from the decompression section 9 (e.g., from 1 bit to 8 bits), and then passes the image data on to the image-quality adjustment section 11. That is, although not shown in FIG. 10, the decompression section 9 and the image-quality adjustment section 11 has the bit-number conversion section provided therebetween.

As shown in FIG. 10, for each pixel, the image-quality adjustment section 11 receives one piece of K image data and generates and outputs three pieces of K image data (all being equal in value). This is because the image display device 104 is a full-color model and as such requires three values for one pixel.

After that, the two-color printing process section 12, the color correction section 13, and the black generation and under color removal section 14 perform no processing on the K image data sent from the image-quality adjustment section 11 and pass the image data directly on the subsequent spatial filter section 15. The spatial filter section 15 performs a blur (smoothing) process and the like on the K image data with use of a digital filter.

The enlarging/reducing section 16 performs a downsampling process on the K image data so that the number of pixels of an image of the K image data sent from the spatial filter section 15 conforms to the number of pixels of the display size of the image display device 104. Further, the enlarging/reducing section 16 enlarges or reduces the image in accordance with an enlarging/reducing command (information indication the zoom ratio of a display, e.g., a fixed zoom ratio of 2 to 4 times) inputted from the operation panel (not shown) provided in the image forming apparatus 100.

The output tone correction section 17 receives the K image data from the enlarging/reducing section 16 and performs output gamma correction on the K image data in conformity to the display characteristics of the image display device 104. Then, the halftone generation section 18 performs no processing on the K image data sent from the output tone correction section 17 and passes the K image data directly on to the subsequence image display device 104. This allows the image display device 104 to display, in accordance with the K image data, a preview of an image received by facsimile.

(3-3) As to Whether the Blocks Operate or Do Not Operate

As described above, at the time of a printing process in the facsimile reception mode, the image-quality adjustment section 11 through the halftone generation section 18 do not operate (see FIG. 9). Meanwhile, at the time of a preview display in the facsimile reception mode, the image-quality adjustment section 11 through the halftone generation section 18 all operate except the two-color printing process section 12, the color correction section 13, the black generation and under color removal section 14, and the halftone generation section 18 (see FIG. 10).

(3-4) Steps of a Process

Next, an example of steps of a process in the facsimile reception mode is described. In cases where the image forming apparatus 100 receives image data by facsimile, the received image data are written temporarily in the storage device 107. It should be noted here that there is a time lag between the writing of the image data in the storage device 107 and printing of an image. In cases where the user inputs a “preview command” during the time lag, the image data is processed along such a flow as shown in FIG. 10, and a preview of an image of the image data is displayed by the image display device 104. Further, when the image is printed, the image data is processed along such a flow as shown in FIG. 9, and the image of the image data is printed by the image output apparatus 103.

(4) Image Transmission Mode

(4-1) Transmission Process (Image Transmission Job)

In the case of operation of the image forming apparatus 100 at the time of a transmission process in the image transmission mode, the image input apparatus 101, the A/D (analog/digital) conversion section 2, the shading correction section 3, the input processing section 4, the automatic document type discrimination section 5, the segmentation process section 6, the compression section 7, the segmentation class signal compression section 8, and the decompression section 9 performs the same processes as in the case of the copier mode. It should be noted that the segmentation class signal decompression section 10 supplies the segmentation class signals to the spatial filter section 15 and the output tone correction section 17.

Then, the image-quality adjustment section 11 performs a background removal process and color balance adjustment. The color correction section 13 converts the image data into R″G″B″ image data (e.g., sRGB data) conforming to the display characteristics of a commonly-used display device. The spatial filter section 15 performs a spatial filter process (edge enhancement process, smoothing process) by a digital filter in accordance with the segmentation class signals. The enlarging/reducing section 16 enlarges or reduces the image. Further, the output tone correction section 17 performs correction on a text area with use of the gamma curve of (b) of FIG. 5, and performs correction on a nontext area with use the gamma curve of (a) of FIG. 5, for example. The two-color printing process section 12 and the black generation and under color removal section 14 perform no processing on the input image data, and each of the blocks passes the image data directly on to the subsequent block. Therefore, the output tone correction section 17 outputs the R″G″B″ image data.

Furthermore, the R″G″B″ image data from the output tone correction section 17 are converted into an image file such as a PDF file by a format conversion process section (not shown). Then, in the scan to e-mail mode, which is an image transmission mode, the image file is attached to an e-mail by the mail processing section (job apparatus; not shown), and the e-mail is transmitted to the destination via a network. Alternatively, in the scan to ftp mode, which is another image transmission mode, the image file is transmitted to a predetermined folder. Alternatively, in the scan to usb mode, which is the other image transmission mode, the image file is transmitted to a predetermined USB memory.

(4-2) Preview Display

In the case of operation of the image forming apparatus 100 at the time of a preview display in the image transmission mode, the image input apparatus 101, the A/D (analog/digital) conversion section 2, the shading correction section 3, the input processing section 4, the automatic document type discrimination section 5, the segmentation process section 6, the compression section 7, the segmentation class signal compression section 8, the decompression section 9, the segmentation class signal decompression section 10, the image-quality adjustment section 11, and the two-color printing process section 12 perform the same processes as in the case of transmission in the image transmission mode.

Then, at the time of a preview display in the image transmission mode, the color correction section 13 converts the RGB image data into R′G′B′ image data conforming to the color space of the image display device 104.

After that, as in the case of transmission, the spatial filter section 15 performs a spatial filter process (edge enhancement process, smoothing process) by a digital filter in accordance with the segmentation class signals. The enlarging/reducing section 16 performs a downsampling process for a match in size for the image display device 104. Further, the output tone correction section 17 performs correction on a text area with use of the gamma curve of (b) of FIG. 5, and performs correction on a nontext area with use the gamma curve of (a) of FIG. 5, for example.

Then, the output tone correction section 17 supplies the R′G′B′ image data to the image display device 104, and the image display device 104 performs a preview display in accordance with the R′G′B′ image data.

(5) Modification

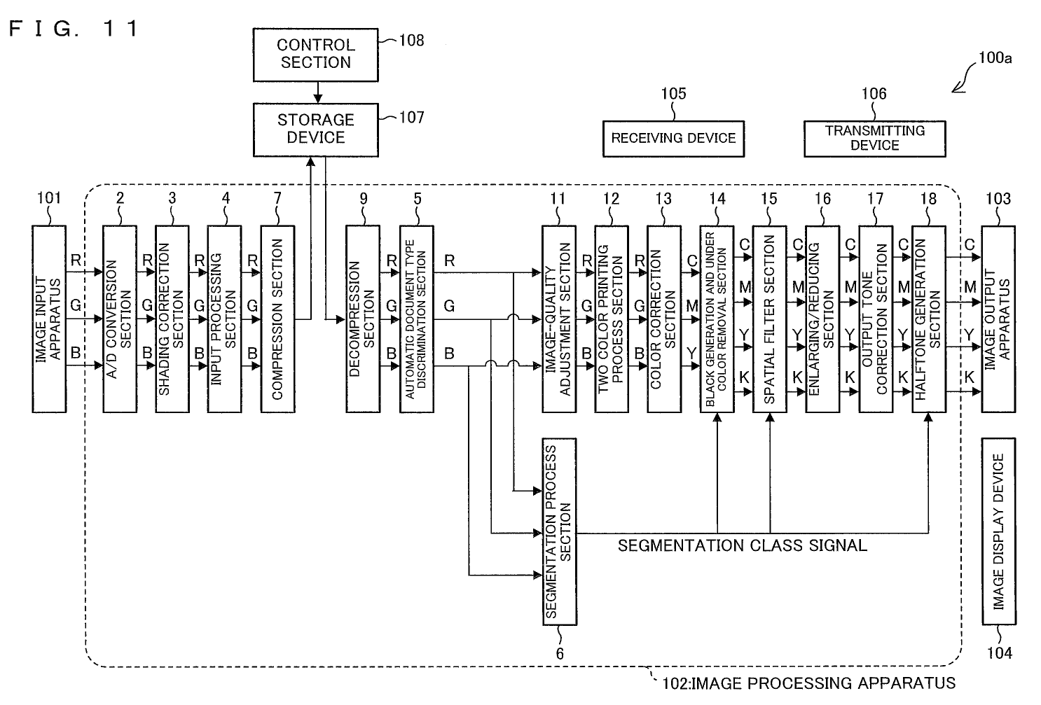

In the image forming apparatus 100 of FIG. 1, the compressed image data (encoded codes) and the segmentation class signal codes are stored in the storage device 107 in association with one another. However, as in an image forming apparatus 100a of FIG. 11, there may be such an arrangement that: after the image input apparatus 101 reads image data, the image data are encoded and stored temporarily in the storage device 107 before a segmentation process and an automatic document type discrimination process; and the image data are read out from the storage device 107, decompressed, and then subjected to a segmentation process and an automatic document type discrimination process.

Further, the image forming apparatus 100 of FIG. 1 may be capable of executing an image filing mode (image filing job) during a job such as the copier mode, the printer mode, the facsimile transmission mode, the facsimile reception mode, or the image transmission mode. The image filing mode is a mode in which to create an image file (e.g., JPEG or TIFF file), during a job such as the copier mode, in accordance with image data obtained by the image input apparatus 101 or image data received from outside and store the image file in the storage device 107.

At the time of filing in the image filing mode, the image data obtained by the image input apparatus 101 or the image data received from outside are converted into an image file (e.g., JPEG or TIFF file) by the image processing apparatus 102. The image filed is sent to a filing processing section (job apparatus; not shown). The filing processing section stores the image file in the storage device 107.

Further, in the case of a preview during each job (e.g., the copier mode, the print mode, or the facsimile transmission mode), the image data obtained by the image input apparatus 101 or the image data received from outside are processed by the image processing apparatus 102, and then sent to the image display device 104, regardless of the execution of the image filing mode. Furthermore, in the case of a preview during each job, the image processing apparatus 102 executes the same image processing regardless of the execution of the image filing mode. For example, at the time of a preview display in the copier mode, the image processing apparatus 102 performs such processes as shown in FIG. 3, regardless of the execution of the image filing mode. Further, at the time of a preview display in the facsimile transmission mode, the image processing apparatus 102 performs such processes as shown in FIG. 8, regardless of the execution of the image filing mode.

(6) Advantages of the Image Processing Apparatus of the Present Embodiment

The image processing apparatus 102 of the present embodiment supplies image data to the image output apparatus (job apparatus, printing apparatus) 103, which performs a print job (copier mode, print mode), and supplies the image data to the image display device 104 so that the image display device 104 displays a preview before the execution of the print job.

Moreover, the image processing apparatus 102 includes a first image processing section which performs first image processing on image data to be supplied to the image output apparatus 103, which performs second image processing on image data to be supplied to the image display device 104, the second image processing being different from the first image processing, and which performs the first image processing and the second image processing with use of a common circuit area. An example of the first image processing section is the color correction section 13 in the copier mode and the full-color mode. This is because the color correction section 13 uses a common circuit area for a process of conversion from RGB into CMY and a process of conversion from RGB into R′G′B′.

This brings about a merit of reducing the circuit size of an image processing circuit even in an image processing apparatus that performs image processing for a printing process or the like and image processing for a preview before the printing process.

Further, in the present embodiment, at the time of printing in the copier mode and the full-color mode, the color correction section 13 performs a process by which additive image data (RGB) read by the scanner and conforming to the characteristics of the scanner are converted into subtractive image data (CMY) conforming to the characteristics of the image output apparatus 103. Meanwhile, at the time of a preview in the copier mode and the full-color mode, the color correction section 13 performs a process by which the additive image data (RGB) read by the scanner and conforming to the characteristics of the scanner are converted into additive image data (R′G′B′) conforming to the characteristics of the image display device 104. That is, at the time of a preview display, the additive image data conforming to the characteristics of the scanner are converted directly into the image data conforming to the characteristics of the image display device 104. Therefore, at the time of a preview display in the copier mode and the full-color mode, the image processing apparatus 102 of the present embodiment performs a single nonlinear conversion from the RGB image data into the R′G′B′ image data, but does not perform a plurality of nonlinear conversions as in the arrangement of Japanese Patent Application Publication, Tokukaihei, 9-135316 A (1997), thus making it possible to suppress accumulation of errors in conversion and suppress deterioration in color reproducibility. In Japanese Patent Application Publication, Tokukaihei, 9-135316 A (1997), a total of four conversions are performed, namely the conversion from RGB data into CMY data, the conversion from CMY data into CMYK data, the conversion from CMYK data into CMY data, and the conversion from the CMY data into RGB data, which result in accumulation of errors in conversion and deterioration in color reproducibility.

Further, at the time of a preview in the copier mode and the single-color mode or at the time of a preview in the copier mode and the two-color mode, the present embodiment performs such a nonlinear conversion, but the number of such nonlinear conversions is only two. Therefore, it is possible to better suppress deterioration in color reproducibility than in the arrangement of Japanese Patent Application Publication, Tokukaihei, 9-135316 A (1997), in which a total of four nonlinear conversions are performed.

Furthermore, in the present embodiment, at the time of printing in the copier mode and the full-color mode, the black generation and under color removal section 14 converts CMY image into CMYK image data; meanwhile, at the time of a preview display in the copier mode and the full-color mode, the black generation and under color removal section 14 performs no processing on R′G′B′ and outputs R′G′B′ directly. This makes it possible to simplify the circuit arrangement by using a common image data path in the image processing circuit for printing image data that needs to be converted from CMY into CMYK and preview image data that does not need to be subjected to a black generation and under color removal process.

The image processing apparatus 102 of the present embodiment can perform image processing based on a result of judgment by the automatic document type discrimination section 5, image processing based on a result of processing by the segmentation process section 6, and a background removal process. The effects of these processes are reflected in a preview image that is displayed by the image display device 104.

### Embodiment 2

In the copier mode of Embodiment 1, at the time of a preview display, the spatial filter section 15 and the output tone correction section 17 perform image processing reflecting the result of a segmentation process. Further, in the facsimile transmission mode of Embodiment 1, at the time of a preview display, the spatial filter section 15 performs image processing reflecting the result of a segmentation process.

Here, at the time of a preview display, it is necessary to perform a downsampling process (process by which the number of pixels is reduced) on image data so that the number of pixels of an image to be processed is matched to the number of pixels of the image display device 104. This is because the number of pixels of a display panel of the image display device 104 is smaller than the number of pixels of an image that is inputted from the image input apparatus 101 (normally, since the display resolution of a display panel is extremely lower that the input resolution of a scanner, the number of the display panel is smaller than the number of pixels of an image that is inputted from the scanner.

Moreover, in the case of downsampling of image data, normally, the image data are downsampled with interpolation (e.g., a bilinear or bicubic interpolation). However, image data composed of segmentation class signals cannot be downsampled with interpolation, but are simply downsampled (i.e., downsampled without interpolation). This causes a lack of image information in some pixels, thus causing deterioration in image quality as a result. For example, as the result of a simple downsampling process performed on image data composed of segmentation class signals, a pixel supposed to be treated as a text is not treated as such; therefore, an image containing a nontext pixel is generated in a text area. This causes degradation in legibility of texts, thus causing deterioration in image quality.

Accordingly, in the present embodiment, at the time of printing in the copier mode, the spatial filter section 15, the black generation and under color removal section 14, and the halftone generation section 18 among the group (image processing section) of the image-quality adjustment section 11 through the halftone generation section 18 perform image processing that varies according to the result of a segmentation process (first image processing), as in Embodiment 1. Further, at the time of a transmission process in the facsimile transmission mode, the spatial filter section 15 among the group (image processing section) of the image-quality adjustment section 11 through the halftone generation section 18 performs image processing that varies according to the result of a segmentation process (first image processing), as in Embodiment 1.

Meanwhile, at the time of a preview display in the copier mode or facsimile transmission mode, the enlarging/reducing section 16 performs a downsampling process; however, the group (image processing section) of the image-quality adjustment section 11 through the halftone generation section 18 does not perform image processing (first image processing) that varies according to the result of a segmentation process, thus inhibiting the occurrence of such a problem as described above.

Moreover, in the present embodiment, unlike in Embodiment 1, at the time of a preview display in the copier mode, the spatial filter section 15 and the output tone correction section 17 among the group (image processing section) of the image-quality adjustment section 11 through the halftone generation section 18 perform image processing (second image processing) irrelevant to the result of a segmentation process. Further, at the time of a preview display in the facsimile transmission mode, the spatial filter section 15 among the group (image processing section) of the image-quality adjustment section 11 through the halftone generation section 18 performs image processing (second image processing) irrelevant to the result of a segmentation process. At the time of a preview display, the image-quality adjustment section 11, the color correction process section 13, the black generation and under color removal section 14, the enlarging/reducing section 16, and the halftone generation section 18 perform the same processes as in Embodiment 1.

That is, at the time of printing in the copier mode or at the time of transmission in the facsimile transmission mode, the present embodiment performs image processing that varies according to the result of a segmentation process. At the time of a preview display in the copier mode or facsimile transmission mode, the present embodiment does not perform image processing that varies according to the result of a segmentation process.

An example of the first image processing that is executed by the spatial filter section 15 is such a filter process that a sharpening filter is used on an image area judged as a text in a segmentation process and a smoothing filter is used on an image area judged as a halftone dot in a segmentation process. Moreover, an example of the second image processing that is executed by the spatial filter section 15 is such a filter process that a smoothing filter is used on all image areas regardless of the type of image area.

Further, an example of the second image processing that is executed by the output tone correction section 17 is such tone correction that a gamma curve for texts to be sharply displayed (see the solid line of (b) of FIG. 5) is used on all image areas regardless of the type of image area.

It should be noted that examples of techniques for performing image processing irrelevant to the result of a segmentation process include Examples 1 to 5 below.

### EXAMPLE 1

Example 1 is a technique which, in the arrangements of FIGS. 1, 3, 7, and 8, reads out segmentation class signal codes (segmentation information) from the storage device (storage section) 107 at the time of a printing process in the copier mode or at the time of a transmission process in the facsimile transmission mode, and which does not read out the segmentation class signal codes from the storage device 107 at the time of a preview display in the copier mode or facsimile transmission mode. This technique is detailed below.

In the case of input of an operation command (operation signal) indicative of an instruction to execute a printing process in the copier mode or an instruction to execute a transmission process in the facsimile transmission mode, the control section (information readout section) 108 reads out the segmentation class signal codes from the storage device 107 and passes them on to the segmentation class signal decompression section 10. Alternatively, in the case of input of an operation command indicative of an instruction to execute a preview process in the copier mode or facsimile transmission mode, the control section 108 does not read out the segmentation class signal codes from the storage device 107.

Thus, at the time of a printing process in the copier mode, the segmentation class signal decompression section 10 can generate segmentation class signals. This makes it possible to input the segmentation class signals (segmentation information) to the black generation and under color removal section 14, the spatial filter section 15, and the halftone generation section 18. Meanwhile, at the time of a preview display in the copier mode, the segmentation class signal decompression section 10 does not generate segmentation class signals. This makes it possible to prohibit input of the segmentation class signals to the spatial filter section 15 and the output tone correction section 17.

Further, it is possible to input the segmentation class signals to the spatial filter section 15 at the time of a transmission process in the facsimile transmission mode, and to prohibit input of the segmentation class signals to the spatial filter section 15 at the time of a preview display in the facsimile transmission mode.

Moreover, the spatial filter section 15 and the output tone correction section 17 are configured to, when receiving no segmentation class signals at the time of a preview display, perform image processing that requires no segmentation class signals. This makes it possible for the spatial filter section 15 and the output tone correction section 17 to, at the time of a preview display in the copier mode, perform image processing that does not vary in content according to one image area to another, instead of performing image processing reflecting the result of a segmentation process. Further, it becomes possible for the spatial filter section 15 to, at the time of a preview display in the facsimile transmission mode, perform image processing that does not vary in content from one image area to another, instead of performing image processing using the result of a segmentation process.

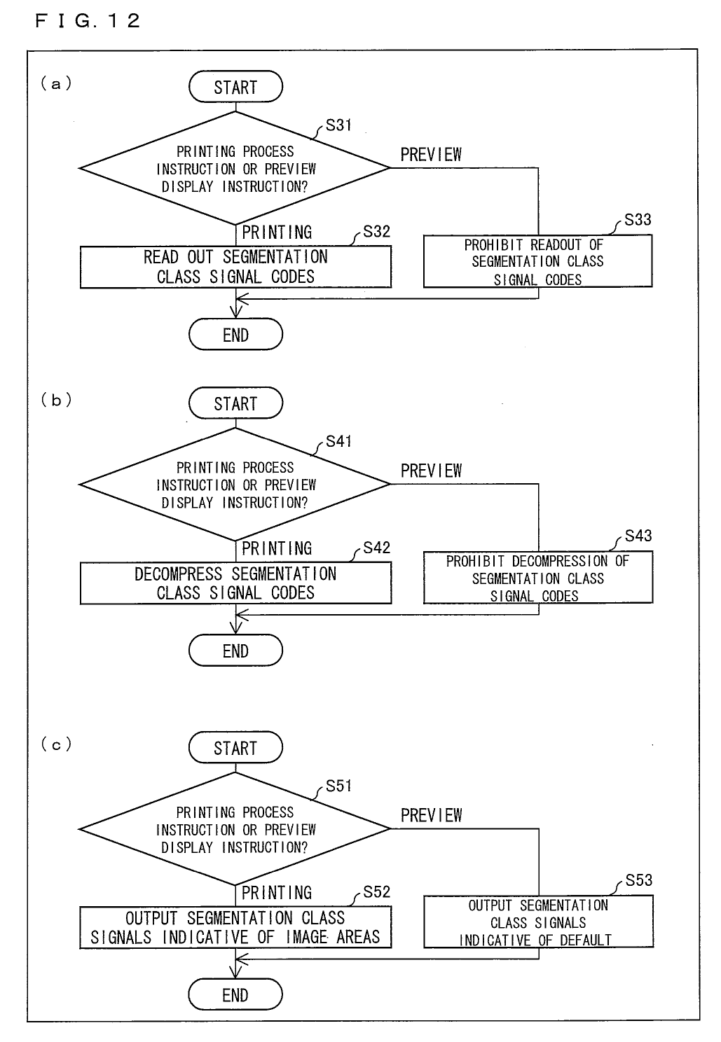

(a) of FIG. 12 is a flow chart showing steps of a process that is performed by the control section 108 at the time of the copier mode in the present embodiment. As shown in (a) of FIG. 12, upon receiving the operation command, the control section 108 judges whether the operation command indicates a printing process instruction or a preview display instruction (S31). Then, when it is judged, in S31, that the operation command indicates a printing process instruction, the control section 108 reads out the segmentation class signal codes from the storage device 107 and passes them on to the segmentation class signal decompression section 10 (S32). Alternatively, in cases where it is judged, in S31, that the operation command indicates a preview display instruction, the control section 108 does not read out the segmentation class signal codes from the storage device 107 (S33), and then finishes the process. This makes it possible to prohibit input of the segmentation class signals to the spatial filter section 15 and the output tone correction section 17 at the time of a preview display process in the copier mode, and makes it possible for the spatial filter section 15 and the output tone correction section 17 to perform image processing that does not vary in content from one image area to another, instead of performing image processing using the result of a segmentation process.

### EXAMPLE 2

Example 2 is a technique which, at the time of a printing process in the copier mode or at the time of a transmission process in the facsimile transmission mode in the arrangements of FIGS. 1, 3, 7, and 8, decompresses the segmentation class signal codes read out from the storage device 107, and which, at the time of a preview display in the copier mode or facsimile transmission mode, does not decompress the segmentation class signal codes read out from the storage device 107. This technique is detailed below.

In the case of input of an operation command indicative of an instruction to execute a printing process in the copier mode, the segmentation class signal decompression section (segmentation information decompression section) 10 decompresses segmentation class signal codes (segmentation information) read out from the storage device 107 and sends them to the black generation and under color removal section 14, the spatial filter section 15, and the halftone generation section 18. Alternatively, in the case of input of an operation command indicative of an instruction to execute a transmission process in the facsimile transmission mode, the segmentation class signal decompression section 10 decompresses the segmentation class signal codes read out from the storage device 107 and sends them to the spatial filter section 15.

Meanwhile, the segmentation class signal decompression section 10 is configured to, in the case of input of an operation command indicative of an instruction to execute a preview process in the copier mode or facsimile transmission mode, neglect to decompress the segmentation class signal codes read out from the storage device 107 and thereby neglect to output segmentation class signals (i.e., neglect to operate).

This makes it possible to input the segmentation class signals (segmentation information) to the black generation and under color removal section 14, the spatial filter section 15, and the halftone generation section 18 at the time of a printing process in the copier mode, and to prohibit input of the segmentation class signals to the spatial filter section 15 and the output tone correction section 17 at the time of a preview display in the copier mode. Further, it is possible to input the segmentation class signals to the spatial filter section 15 at the time of a transmission process in the facsimile transmission mode, and to prohibit input of the segmentation class signals to the spatial filter section 15 at the time of a preview display in the facsimile transmission mode.

Moreover, the spatial filter section 15 and the output tone correction section 17 are configured to, when receiving no segmentation class signals at the time of a preview display, perform image processing that requires no segmentation class signals. This makes it possible for the spatial filter section 15 and the output tone correction section 17 to, at the time of a preview display in the copier mode, perform image processing that does not vary in content from one image area to another, instead of performing image processing reflecting the result of a segmentation process. Further, it becomes possible for the spatial filter section 15 to, at the time of a preview display in the facsimile transmission mode, perform image processing that does not vary in content from one image area to another, instead of performing image processing using the result of a segmentation process.

(b) of FIG. 12 is a flow chart showing steps of a process that is performed by the segmentation class signal decompression section 10 at the time of the copier mode in the present embodiment. As shown in (b) of FIG. 12, upon receiving the operation command, the segmentation class signal decompression section 10 judges whether the operation commend indicates a printing process instruction or a preview display instruction (S41). Then, when it is judged, in S41, that the operation commend indicates a printing process instruction, the segmentation class signal decompression section 10 decompresses the segmentation class signal codes read out from the storage device 107 and sends them to the black generation and under color removal section 14, the spatial filter section 15, and the halftone generation section 18 (S42). Alternatively, when it is judged, in S41, that the operation commend indicates a preview display instruction, the segmentation class signal decompression section 10 does not the segmentation class signal codes read out from the storage device 107 (S43), and then finishes the process. This makes it possible to prohibit input of the segmentation class signals to the spatial filter section 15 and the output tone correction section 17 at the time of a preview display process in the copier mode, and makes it possible for the spatial filter section 15 and the output tone correction section 17 to perform image processing that does not vary in content from one image area to another, instead of performing image processing using the result of a segmentation process.

### EXAMPLE 3

Example 3 is a technique in which, at the time of a printing process in the copier mode or at the time of a transmission process in the facsimile transmission mode in the arrangements of FIGS. 1, 3, 7, and 8, the segmentation class signal decompression section 10 outputs segmentation class signals indicative of image areas for each pixel (signals indicative of the result of a segmentation process), and in which, at the time of a preview display in the copier mode or facsimile transmission mode, the segmentation class signal decompression section 10 outputs segmentation class signals indicative of default (signals not indicative of the result of a segmentation process). This technique is detailed below.

In the case of input an operation command indicative of an instruction to execute a printing process in the copier mode, the segmentation class signal decompression section (segmentation information supply section) 10 decompresses segmentation class signal codes read out from the storage device 107 and sends them to the black generation and under color removal section 14, the spatial filter section 15, and the halftone generation section 18. Alternatively, in the case of input of an operation command indicative of an instruction to execute a transmission process in the facsimile transmission mode, the segmentation class signal decompression section 10 decompresses the segmentation class signal codes read out from the storage device 107 and sends them to the spatial filter section 15.

Meanwhile, in the case of input of an operation command indicative of an instruction to execute a preview process in the copier mode or facsimile transmission mode, the segmentation class signal decompression section 10 ignores the segmentation class signal codes read out from the storage device 107 and transmits the segmentation class signals indicative of default to the spatial filter section 15 and the output tone correction section 17 (or to the spatial filter section 15 alone in a preview process in the facsimile transmission mode) for each pixel. The “segmentation class signals indicative of default” here mean signals indicating that they do not belong to any image area.

This makes it possible to input the segmentation class signals indicative of image area (signals indicative of the result of a segmentation process) to the black generation and under color removal section 14, the spatial filter section 15, and the halftone generation section 18 at the time of a printing process in the copier mode, and to input the segmentation class signals indicative of default (signals not indicative of the result of a segmentation process) to the spatial filter section 15 and the output tone correction section 17 at the time of a preview display in the copier mode. Further, it is possible to input the segmentation class signals indicative of image areas to the spatial filter section 15 at the time of a transmission process in the facsimile transmission mode, and to input the default segmentation class signals to the spatial filter section 15 at the time of a preview display in the facsimile transmission mode.

Moreover, the spatial filter section 15 and the output tone correction section 17 are configured to perform predetermined image processing upon receiving the segmentation class signals indicative of default.

According to the foregoing arrangement, the spatial filter section 15 and the output tone correction section 17 receive segmentation class signals identical in content for all pixels (segmentation class signals indicative of default) at the time of a preview display, instead of receiving segmentation class signals decompressed from the segmentation class signal codes. This makes it possible to perform image processing that does not vary in content from one image area to another (i.e., image processing that does not reflect the result of a segmentation process).

(c) of FIG. 12 is a flow chart showing steps of a process that is performed by the segmentation class signal decompression section 10 at the time of the copier mode in the present embodiment. As shown in (c) of FIG. 12, upon receiving the operation command, the segmentation class signal decompression section 10 judges whether the operation commend indicates a printing process instruction or a preview display instruction (S51). Then, when it is judged, in S51, that the operation commend indicates a printing process instruction, the segmentation class signal decompression section 10 decompresses the segmentation class signal codes read out from the storage device 107 and sends them to the black generation and under color removal section 14, the spatial filter section 15, and the halftone generation section 18 (S52). Alternatively, when it is judged, in S51, that the operation commend indicates a preview display instruction, the segmentation class signal decompression section 10 ignores the segmentation class signal codes read out from the storage device 107 and transmits the default segmentation class signals to the spatial filter section 15 and the output tone correction section 17 for all pixels (S53). This makes it possible for the spatial filter section 15 and the output tone correction section 17 to, at the time of a preview display process in the copier mode, perform image processing that does not vary in content from one image area to another, instead of performing image processing reflecting the result of a segmentation process.

It should be noted that the segmentation class signal decompression section 10 may transmit dummy signals for all pixels in the case of input of an operation command indicative of an instruction to execute a preview process in the copier mode or facsimile transmission mode, instead of transmitting the segmentation class signals indicative of default. Further, the spatial filter section 15 and the output tone correction section 17 are configured to perform predetermined image processing upon receiving dummy signals at the time of a preview display. This makes it possible for the spatial filter section 15 and the output tone correction section 17 to, at the time of a preview display, perform image processing that does not vary in content from one image area to another, instead of performing image processing reflecting the result of a segmentation process. The “dummy signals” here do not mean signals indicative of image areas but means signals that make no sense.

Further, the technique of Example 3 can be applied to an arrangement of FIG. 11. The following describes an example of the copier mode where the technique of Example 3 is applied to the arrangement of FIG. 11. In the case of input of an operation command indicative of an instruction to execute a printing process in the copier mode, the segmentation process section 6 performs a segmentation process for each pixel, and then transmits segmentation class signals indicative of image areas to the black generation and under color removal section 14, the spatial filter section 15, and the halftone generation section 18. Alternatively, in the case of input of an operation command indicative of an instruction to execute a preview process in the copier mode, the segmentation process section 6 transmits segmentation class signals indicative of default (or dummy signals) to the spatial filter section 15 and the output tone correction section 17 for all pixels. This makes it possible for the spatial filter section 15 and the output tone correction section 17 to, at the time of a preview display, perform image processing that does not vary in content from one image area to another, instead of performing image processing reflecting the result of a segmentation process.

### EXAMPLE 4

Example 4 is a technique in which, at the time of a printing process in the copier mode or at the time of a transmission process in the facsimile transmission mode, the spatial filter section 15 and the like select the contents of image processing according to the received segmentation class signals with reference to the segmentation class signals, and in which, at the time of a preview display, the spatial filter section 15 and the like ignore (do not refer to) the received segmentation class signals. The following describes an embodiment in which the technique of Example 4 is applied to the arrangements of FIGS. 1, 3, 7, and 8.

In the case of input of an operation command indicative of an instruction to execute a printing process in the copier mode, the segmentation class signal decompression section (segmentation information supply section) 10 decompresses segmentation class signal codes read out from the storage device 107 and sends them to the black generation and under color removal section 14, the spatial filter section 15, and the halftone generation section 18. Alternatively, in the case of input of an operation command indicative of an instruction to execute a transmission process in the facsimile transmission mode, the segmentation class signal decompression section 10 decompresses the segmentation class signal codes read out from the storage device 107 and sends them to the spatial filter section 15.

Meanwhile, in the case of input of an operation command indicative of an instruction to execute a preview process in the copier mode, the segmentation class signal decompression section 10 decompresses the segmentation class signal codes read out from the storage device 107 and sends them to the spatial filter section 15 and the output tone correction section 17. Alternatively, in the case of input of an operation command indicative of an instruction to execute a preview process in the facsimile transmission mode, the segmentation class signal decompression section 10 decompresses the segmentation class signal codes read out from the storage device 107 and sends them to the spatial filter section 15.

Moreover, the spatial filter section 15 and the output tone correction section 17 are configured to, in the case of input of an operation command indicative of an instruction to execute a preview process in the copier mode, ignore (neglect to refer to) the received segmentation class signals and perform predetermined image processing (that requires no segmentation class signals). Further, the spatial filter section 15 is configured to, in the case of input of an operation command indicative of an instruction to execute a preview process in the facsimile transmission mode, ignore (neglect to refer to) the received segmentation class signals and perform predetermined image processing (that requires no segmentation class signals).

This makes it possible for the spatial filter section 15 and the output tone correction section 17 to, at the time of a preview display, perform image processing that does not vary in content from one image area to another, instead of performing image processing reflecting the result of a segmentation process.

It should be noted that the technique of Example 4 can be applied to the arrangement of FIG. 11. However, in the arrangement of FIG. 11, it is not the segmentation class signal decompression section 10 but the segmentation process section 6 that inputs the segmentation class signals to the spatial filter section 15 and the like.

### EXAMPLE 5

Example 5 is a technique that allows the segmentation process section 6 to operate at the time of a printing process in the copier mode or at the time of a transmission process in the facsimile transmission mode and does not allow it to operate at the time of a preview display in the copier mode or facsimile transmission mode. This technique is detailed below. It should be noted that the technique of Example 5 can be applied to the arrangement of FIG. 11.

In the case of input of an operation command (operation signal) indicative of an instruction to execute a printing process in the copier mode or an instruction to execute a transmission process in the facsimile transmission mode, the segmentation process section 6 performs a segmentation process in accordance with RGB image data sent from the automatic document type discrimination section 5 and outputs segmentation class signals indicative of a result of the segmentation process. Alternatively, in the case of input of an operation command indicative of an instruction to execute a preview process in the copier mode or facsimile transmission mode, the segmentation process section 6 does not perform a segmentation process even when receiving RGB image data from the automatic document type discrimination section 5, and does not generate segmentation class signals (does not operate), either.

This prevents the spatial filter section 15 and the output tone correction section 17 from being supplied with segmentation class signals at the time of a preview display. Moreover, the spatial filter section 15 and the output tone correction section 17 are configured to, when receiving no segmentation class signals at the time of a preview display, perform image processing that requires no segmentation class signals. This makes it possible for the spatial filter section 15 and the output tone correction section 17 to perform image processing identical in content regardless of image areas, instead of performing image processing using the result of a segmentation process.

It is preferable that at the time of a printing process in the copier mode and at the time of a transmission process in the facsimile transmission mode, the spatial filter section 15 perform a sharpening process on a text area and a smoothing process on a halftone dot area. This makes it possible to enhance the contour of a text to enhance legibility, and to suppress moire in a halftone dot. Meanwhile, at the time of a preview display in the copier mode and the facsimile transmission mode, the spatial filter section 15 performs image processing that does not vary in content from one image area to another. Specifically, it is preferable that the spatial filter section 15 perform a smoothing process using a smoothing filter (blurring filter) regardless of the type of image area. The reason for this is as follows: The inventors studied and found out that a downsampling process that is performed on a blurred image by the enlarging/reducing section 16 at the time of a preview results in better suppression of degradation in legibility of texts due to downsampling than does a downsampling process that is performed on an unblurred image.

Further, at the time of a preview display in the copier mode, the output tone correction section 17 performs image processing that does not vary in content from one image area to another, too. It is preferable that the output tone correction section 17 perform gamma correction using a gamma curve (see (b) of FIG. 5) for texts to be sharply displayed. This makes it possible to suppress degradation in legibility of texts even when the image is downsampled by the enlarging/reducing section 16.

The present embodiment has omitted an explanation about the image transmission mode. However, as in the copier mode or facsimile transmission mode, it is possible to, at the time of transmission in the image transmission mode, perform image processing (first image processing) that varies according to the result of a segmentation process, and to, at the time of a preview display in the image transmission mode, perform image processing (second image processing) irrelevant to the result of a segmentation process, instead of performing image processing that varies according to the result of a segmentation process. That is, as in the copier mode or facsimile transmission mode, it is possible to apply the techniques of Examples 1 to 5 in the image transmission mode. Furthermore, it is preferable that at the time of a transmission process in the image transmission mode, as in the case of a printing process in the copier mode and the case of a transmission process in the facsimile transmission mode, the spatial filter section 15 perform a sharpening process on a text area and a smoothing process on a halftone dot area. Meanwhile, it is preferable that at the time of a preview display in the image transmission mode, as in the case of a printing process in the copier mode and the case of a transmission process in the facsimile transmission mode, the spatial filter section 15 perform a smoothing process using a smoothing filter (blurring filter) regardless of the type of image area.

The present embodiment can be achieved by storing, in a computer-readable storage medium containing control program code (executable program, intermediate code program, or source program) to be executed by a computer, an image processing method for, when the image data are data for use in printing or facsimile transmission, performing first image processing that varies according to a result of the segmentation process, and for, when the image data are data for use in a preview display, performing a downsampling process on the image data and performing a preview without performing the first image processing. This makes it possible to provide a portable storage medium containing a program for the image processing method.

In the present embodiment, the storage medium may be a memory (not shown) for processing in a microcomputer. For example, the storage medium may be a program medium such as a ROM per se. Alternatively, the storage medium may be a program medium that can read by inserting the storage medium into a program reading device provided as an external storage device (not shown).

In either case, the contained program code may be arranged to be accessible to a microprocessor that will execute the program code. Alternatively, the program code may be arranged to be read and then downloaded to a program storage area (not shown) of the microcomputer. It is assumed that the download program is stored in advance in the main apparatus.

It should be noted here that the program medium is a storage medium arranged to be separable from the main body. The storage medium may be, for example, a tape, such as a magnetic tape or a cassette tape; a magnetic disk, such as a flexible disk or a hard disk, or an optical disk, such as CD-ROM/MO/MD/DVD; a card, such as an IC card (memory card) or an optical card; or a semiconductor memory, such as a mask ROM/EPROM (erasable programmable read-only memory)/EEPROM (electrically erasable programmable read-only memory)/flash ROM. All these storage media hold a program in a fixed manner.

Alternatively, since the present embodiment is a system configuration connectable to communication networks including the Internet, the program medium may be a medium carrying the program code in a flowing manner as in the downloading of a program over a communication network. Further, when the program code is downloaded over a communications network in this manner, the download program may be stored in advance in the main apparatus or installed from another storage medium. The present invention can be realized in the form of a computer data signal, embedded in a carrier wave, in which the program code is embodied electronically. The storage medium is read by a digital color image forming apparatus of a program reading device provided in a computer system, whereby the aforementioned image processing method is executed.

In order to attain the foregoing object, the present invention is characterized by an image processing apparatus including: a segmentation process section which performs a segmentation process on image data; and an image processing section which performs image processing on the image data, when the image data are data for use in printing or transmission, the image processing section performing first image processing that varies according to a result of the segmentation process, when the image data are data for use in a preview display, the image processing section performing a downsampling process on the image data and neglecting to perform the first image processing.

The arrangement of the present invention does not subject image data for use in a preview display to image processing reflecting the result of a segmentation process, thus bringing about an effect of suppressing deterioration in quality of an image whose preview is displayed.

Further, when the image data are data for use in printing or transmission, the image processing section needs segmentation information indicative of the result of the segmentation process in order to change the contents of the image processing according to the result of the segmentation process. However, when the image data are data for use in a preview display, the image processing section does not needs segmentation information indicative of the result of the segmentation process, because it does not perform the first image processing.

Accordingly, in addition to the foregoing arrangement, the image processing apparatus of the present invention may be arranged to further include: a storage section in which to store segmentation information indicative of the result of the segmentation process after the segmentation process; and an information readout section which, when the image data are data for use in printing or transmission, reads out the segmentation information from the storage section and inputting the segmentation information to the image processing section, and which, when the image data are data for use in a preview display, does not read out the segmentation information from the storage section.

Further, in addition to the foregoing arrangement, the image processing apparatus of the present invention may be arranged to further include: a segmentation information compression section which compresses segmentation information indicative of the result of the segmentation process after the segmentation process; and a segmentation information decompression section which, when the image data are data for use in printing or transmission, decompresses the compressed segmentation information and inputs the decompressed segmentation information to the image processing section, and which, when the image data are data for use in a preview display, does not decompress the compressed segmentation information.

Furthermore, in addition to the foregoing arrangement, the image processing apparatus of the present invention may be arranged to further include a segmentation information supply section which supplies segmentation information indicative of the result of the segmentation process to the image processing section when the image data are data for use in printing or transmission, and which supplies dummy information to the image processing section instead of the segmentation information when the image data are data for use in a preview display.

Further, in addition to the foregoing arrangement, the image processing apparatus of the present invention may be arranged to further include a segmentation information supply section which supplies segmentation information indicative of the result of the segmentation process to the image processing section when the image data are data for use in printing or transmission, and which supplies segmentation information not indicative of the result of the segmentation process but indicative of default to the image processing section when the image data are data for use in a preview display.

However, even when the image data are data for use in a preview display, it is without any problem to supply the segmentation information indicative of the result of the segmentation process to the image processing section. In this case, in addition to the foregoing arrangement, the image processing apparatus of the present invention is preferably arranged to further include a segmentation information supply section which supplies segmentation information indicative of the result of the segmentation process to the image processing section, wherein: when the image data are data for use in printing or transmission, the image processing section refers to segmentation information supplied from the segmentation information supply section; and when the image data are data for use in a preview display, the image processing section does not refer to the segmentation information supplied from the segmentation information supply section. Further, the image processing apparatus of the present invention may be arranged such that: when the image data are data for use in printing or transmission, the image processing section changes contents of the first image processing according to contents of the segmentation information supplied from the segmentation information supply section; and when the image data are data for use in a preview display, the image processing section performs second image processing irrelevant to the segmentation process.

Further, the image processing apparatus of the present invention performs, on image data for use in printing or transmission, first image processing that varies according to the result of the segmentation process, and does not perform the first image processing on image data for use in a preview display. Therefore, whereas the segmentation process is needed at the time of processing of image data for use in printing or transmission, the segmentation process is not needed at the time of processing of image data for use in a preview display. Accordingly, the image processing apparatus of the present invention may be arranged such that: the segmentation process section performs the segmentation process when the image data are data for use in printing or transmission; and the segmentation process section does not perform the segmentation process when the image data are data for use in a preview display.

Further, the image processing apparatus of the present invention is preferably arranged such that: the image processing section performs second image processing irrelevant to the segmentation process on the image data when the image data are data for use in a preview display; the first image processing is performing a sharpening process on a text image area and a smoothing process on a halftone dot image area; and the second image processing is performing a smoothing process regardless of type of image area prior to the downsampling process. This makes it possible to enhance the legibility of texts in an image whose preview is displayed.

Furthermore, the present invention may be an image forming apparatus including such an image processing apparatus as described above. Further, the present invention may be a method for controlling an image processing apparatus including a segmentation process section which performs a segmentation process on image data and an image processing section which performs image processing on the image data, the method comprising the steps of: when the image data are data for use in printing or transmission, causing the image processing section to perform first image processing that varies according to a result of the segmentation process; and when the image data are data for use in a preview display, causing the image processing section to perform a downsampling process on the image data and prohibiting the image processing section from performing the first image processing.

Each section of the image processing apparatus of the present invention may be realized by a computer. In this case, a control program for operation a computer as each section and a computer-readable storage medium containing such a control program are also encompassed in the scope of the present invention.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below. Further, the numerical values outside of the ranges shown in this specification are encompassed in the present invention as long as such ranges are rational ranges that do not defeat the purpose of the present invention.

### INDUSTRIAL APPLICABILITY

An image processing apparatus of the present invention can be used for apparatuses for processing image data and, in particular, for multifunction printers, copying machines, printers, and facsimile machines.

1. An image processing apparatus comprising:
a segmentation process section which performs a segmentation process on image data; and
an image processing section which performs image processing on the image data,
when the image data are data for use in printing or transmission, the image processing section performing first image processing that varies according to a result of the segmentation process, when the image data are data for use in a preview display, the image processing section performing a downsampling process on the image data and neglecting to perform the first image processing.

2. The image processing apparatus as set forth in claim 1, further comprising:
a storage section in which to store segmentation information indicative of the result of the segmentation process after the segmentation process; and
an information readout section which, when the image data are data for use in printing or transmission, reads out the segmentation information from the storage section and inputs the segmentation information to the image processing section, and which, when the image data are data for use in a preview display, does not read out the segmentation information from the storage section.

3. The image processing apparatus as set forth in claim 1, further comprising:
a segmentation information compression section which compresses segmentation information indicative of the result of the segmentation process after the segmentation process; and
a segmentation information decompression section which, when the image data are data for use in printing or transmission, decompresses the compressed segmentation information and inputs the decompressed segmentation information to the image processing section, and which, when the image data are data for use in a preview display, does not decompress the compressed segmentation information.

4. The image processing apparatus as set forth in claim 1, further comprising a segmentation information supply section which supplies segmentation information indicative of the result of the segmentation process to the image processing section when the image data are data for use in printing or transmission, and which supplies dummy information to the image processing section instead of the segmentation information when the image data are data for use in a preview display.

5. The image processing apparatus as set forth in claim 1, further comprising a segmentation information supply section which supplies segmentation information indicative of the result of the segmentation process to the image processing section when the image data are data for use in printing or transmission, and which supplies segmentation information not indicative of the result of the segmentation process but indicative of default to the image processing section when the image data are data for use in a preview display.

6. The image processing apparatus as set forth in claim 1, further comprising a segmentation information supply section which supplies segmentation information indicative of the result of the segmentation process to the image processing section, wherein: when the image data are data for use in printing or transmission, the image processing section refers to segmentation information supplied from the segmentation information supply section; and when the image data are data for use in a preview display, the image processing section does not refer to the segmentation information supplied from the segmentation information supply section.

7. The image processing apparatus as set forth in claim 1, wherein:
the segmentation process section performs the segmentation process when the image data are data for use in printing or transmission; and
the segmentation process section does not perform the segmentation process when the image data are data for use in a preview display.

8. The image processing apparatus as set forth in claim 6, wherein:
when the image data are data for use in printing or transmission, the image processing section changes contents of the first image processing according to contents of the segmentation information supplied from the segmentation information supply section; and
when the image data are data for use in a preview display, the image processing section performs second image processing irrelevant to the segmentation process.

9. The image processing apparatus as set forth in claim 8, wherein:
the first image processing is performing a sharpening process on a text image area and a smoothing process on a halftone dot image area; and
the second image processing is performing a smoothing process regardless of type of image area prior to the downsampling process.

10. The image processing apparatus as set forth in claim 1, wherein:
the image processing section performs second image processing irrelevant to the segmentation process on the image data when the image data are data for use in a preview display;
the first image processing is performing a sharpening process on a text image area and a smoothing process on a halftone dot image area; and
the second image processing is performing a smoothing process regardless of type of image area prior to the downsampling process.

11. An image forming apparatus comprising an image processing apparatus as set forth in claim 1.

12. A method for controlling an image processing apparatus including a segmentation process section which performs a segmentation process on image data and an image processing section which performs image processing on the image data, the method comprising the steps of:
when the image data are data for use in printing or transmission, causing the image processing section to perform first image processing that varies according to a result of the segmentation process; and
when the image data are data for use in a preview display, causing the image processing section to perform a downsampling process on the image data and prohibiting the image processing section from performing the first image processing.

13. A computer-readable storage medium containing a control program for controlling an image processing apparatus as set forth in claim 1, the control program causing a computer to operate as each section of the image processing apparatus.
